(19) United States
(12) Patent Application Publication
(10) Pub. No.: US 2024/0071189 A1
(43) Pub. Date: Feb. 29, 2024

(54) Providing and Using a Monitoring Service

(71) Applicant: AT&T Intellectual Property I, L.P., Atlanta, GA (US)

(72) Inventors: Wei Wang, Harrison, NJ (US); Lars Johnson, Brooklyn, NY (US)

(73) Assignee: AT&T Intellectual Property I, L.P., Atlanta, GA (US)

(21) Appl. No.: 17/899,746

(22) Filed: Aug. 31, 2022

(51) Int. Cl. G08B 13/196; G06V 20/40; G06V 20/52; H04N 7/18

(52) U.S. Cl. CPC G08B 13/196; G06V 20/40; G06V 20/52; H04N 7/188

(57) ABSTRACT

Providing and using a monitoring service can include detecting a monitoring trigger that indicates that monitoring of a user device is to be initiated. A time period associated with the monitoring can be identified. The monitoring of the user device can be triggered, where the monitoring can include obtaining video associated with the user device that is streamed to an edge device, wherein the video can be analyzed to determine if a threat is detected. If a determination is made that the threat is not detected, termination of the monitoring and deletion of the video can be triggered. If a determination is made that the threat is detected, delivery of an alert to another device can be triggered.

### BACKGROUND

Personal safety and security have been growing concerns for the general public over the years. With portable computing devices becoming commonplace in modern society, the ability to communicate at almost all times has become an expectation and a reality. Along with this ability has come various ways to use the communications.

Sharing of video has also become popular over the years as a form of social networking and/or monitoring. Streaming live events and/or live scenes has become popular in many situations. At the same time, networking users have become more aware and attuned to privacy concerns and often prefer that their data be deleted after use or that their data not be seen or used unless the user requests disclosure or use of the data.

### SUMMARY

The present disclosure is directed to providing and using a monitoring service. Monitoring of a user, device, or other entity can be prompted by a user or other entity. In some embodiments, the monitoring can be requested explicitly, e.g., by requesting monitoring, while in some other embodiments the monitoring can be triggered based on captured data that can be generated by a user device associated with the user. In some embodiments, a user or other entity may activate monitoring with a specified time duration. If the time duration expires without the user deactivating the monitoring, the content can be analyzed to determine if a threat exists and to prompt remedial action by way of generating commands and/or alerts to one or more entities (e.g., first responders, other users in the area, etc.). In various embodiments, the monitoring can be accomplished by streaming data such as sensor readings, video, audio, and the like to an edge device of a network. Such edge devices may have enough bandwidth and processing power to process such streams without impacting performance of the edge device. If analysis reveals a threat to the user or other entity, alerts or stream files can be sent by the edge device to a local or remote service, which can be configured to alert one or more entities with warnings and/or responses. If the analysis reveals no threat, or if the user terminates the monitoring before a specified or designated time duration ends, stream files and/or other copies of the streaming data can be permanently deleted to protect the privacy of the user.

According to some embodiments, a user or other entity associated with a device (e.g., a smartphone, a gateway, a computer, a vehicle, or other device) can register for, sign up for, or otherwise obtain features associated with a monitoring service. In some embodiments, the registration process can include opting-in for monitoring and/or installation of a monitoring application. In some other embodiments, the monitoring application can be built into the operating system and/or other applications installed and/or hosted by the user device. The monitoring application can be configured to monitor activities and/or tasks occurring at, near, and/or with the user device. The monitoring application also can be configured to capture various types of information and/or data at various times. The captured data can include contextual data that can describe tasks occurring at or near the user device; event and/or trigger data; geolocation data that can indicate a physical location of the user device; connection data that can identify one or more active or available network connections at or associated with the user device; streaming data such as video, audio, sensor readings, or the like; and/or other data. In some embodiments, other devices at or in proximity to the user device can also be configured to capture these and/or other data. The captured data can be provided by the user device and/or the other devices to a monitoring service.

According to various implementations of the concepts and technologies disclosed herein, the monitoring service can be executed and/or hosted by a server computer, an edge device, and/or other devices or entities. The monitoring service also can be configured to obtain one or more user models in some embodiments, where the user models can describe trends and/or histories associated with tasks or operations performed at the user device and/or various aspects of these tasks or operations such as frequency, duration, etc. The monitoring service also can be configured to obtain other information from one or more data sources such as crime reporting devices, news reporting devices, social networking entities, network monitoring devices, etc. Thus, the other information can include crime reports, news reports, events, alerts, social networking information, combinations thereof, or the like.

The monitoring service can be configured to determine, e.g., based on the captured data, the user models, the other information, and/or other considerations, if monitoring of the user device is to be initiated. The determination to initiate monitoring of the user device also can be made by receiving an explicit request for monitoring from the user device and/or other entities such as the data sources, social networking connections or services, and/or the other devices or entities. When a decision is made to initiate monitoring, the monitoring service can determine a time duration for the monitoring and generate one or more commands (or trigger generation of the commands) to trigger the monitoring. In some embodiments, a timer job can be initiated for the determined time duration when monitoring is commenced, and expiration of the timer job can trigger termination of the monitoring, alerting (if monitoring is not terminated before that time), analysis of captured information, and/or other operations. The monitoring service also can be configured to trigger delivery of the one or more commands, where the commands can include computer-executable code that, when executed by a device that receives the commands, causes the device to initiate monitoring of the user device or perform other operations or tasks.

Monitoring of the user device can include streaming various types of data (e.g., as part of one or more releases, streams, and/or iterations of the captured data) to the monitoring service (e.g., executed at the server computer and/or the edge device). In some embodiments, the streamed data (e.g., video, audio, location data, sound data, bearing data, orientation data, sensor readings, etc.) can be provided to the edge device for analysis. The edge device and/or other entities can be configured to analyze the streamed data and determine, e.g., via application of machine learning logic and/or artificial intelligence, if there exists a security and/or safety threat. If a threat is detected, one or more devices can be configured to generate one or more alerts to prompt the sending of assistance to the user device and/or to otherwise address the threat. If no threat is detected, the monitoring service can be configured to delete copies of the streamed data (e.g., the stream file) to preserve privacy of the user and/or for other reasons. If, after detecting a threat and/or generating alerts, it is determined that a threat has ended, alerts can be cancelled in some embodiments.

According to one aspect of the concepts and technologies disclosed herein, a system is disclosed. The system can include a processor and a memory. The memory can store computer-executable instructions that, when executed by the processor, cause the processor to perform operations. The operations can include detecting a monitoring trigger that indicates that monitoring of a user device is to be initiated; identifying a time period associated with the monitoring; and triggering the monitoring of the user device. The monitoring can include obtaining video associated with the user device, and the video can be streamed to an edge device. The operations further can include analyzing the video to determine if a threat is detected. If a determination is made that the threat is not detected, the operations can include triggering termination of the monitoring and deletion of the video. If a determination is made that the threat is detected, the operations can include triggering delivery of an alert to another device.

In some embodiments, the computer-executable instructions, when executed by the processor, can cause the processor to perform operations further including determining, during the monitoring, that the monitoring has not been deactivated; determining, during the monitoring, that the time period has lapsed; and analyzing the video in response to determining that the time period has lapsed without the monitoring being deactivated. In some embodiments, the time period can include an amount of time for which the monitoring is to be performed. In some embodiments, detecting the monitoring trigger can include detecting selection, at the user device, of a control to begin monitoring of the user device.

In some embodiments, detecting the monitoring trigger can include detecting selection, at the user device, of a control to begin monitoring of the user device after the time period if the monitoring is not deactivated before the time period lapses; determining that the time period lapsed; and determining that the monitoring was not deactivated before the time period lapsed. In some embodiments, determining that the monitoring has been deactivated can include determining that an explicit request to deactivate the monitoring has been received from the user device. In some embodiments, determining that the monitoring has been deactivated can include detecting initiation of a network connection between the user device and another device.

According to another aspect of the concepts and technologies disclosed herein, a method is disclosed. The method can include detecting, at a computer including a processor, a monitoring trigger that indicates that monitoring of a user device is to be initiated; identifying, by the processor, a time period associated with the monitoring; and triggering, by the processor, the monitoring of the user device. The monitoring can include obtaining video associated with the user device, and the video can be streamed to an edge device. The method further can include analyzing, by the processor, the video to determine if a threat is detected. If a determination is made that the threat is not detected, the method can include triggering, by the processor, termination of the monitoring and deletion of the video. If a determination is made that the threat is detected, the method can include triggering, by the processor, delivery of an alert to another device.

In some embodiments, the method can further include determining, during the monitoring, that the monitoring has not been deactivated; determining, during the monitoring, that the time period has lapsed; and analyzing the video in response to determining that the time period has lapsed without the monitoring being deactivated. In some embodiments, detecting the monitoring trigger can include detecting selection, at the user device, of a control to begin monitoring of the user device after the time period if the monitoring is not deactivated before the time period lapses; determining that the time period lapsed; and determining that the monitoring was not deactivated before the time period lapsed.

In some embodiments, triggering delivery of the alert can include identifying a geographic location of the user device; identifying, based on the geographic location, two or more devices that are located in proximity to the user device, the two or more devices including the other device; and triggering the delivery of the alert to the other device. In some embodiments, the method can further include in response to determining that the alert should be cancelled, cancelling the alert, where determining that the alert should be cancelled can include determining that the other device is no longer in proximity to the user device. In some embodiments the method can further include in response to determining that the alert should be cancelled, cancelling the alert, wherein determining that the alert should be cancelled can include receiving a notification that help is no longer needed at the user device.

According to yet another aspect of the concepts and technologies disclosed herein, a computer storage medium is disclosed. The computer storage medium can store computer-executable instructions that, when executed by a processor, cause the processor to perform operations. The operations can include detecting a monitoring trigger that indicates that monitoring of a user device is to be initiated; identifying a time period associated with the monitoring; and triggering the monitoring of the user device. The monitoring can include obtaining video associated with the user device, and the video can be streamed to an edge device. The operations further can include analyzing the video to determine if a threat is detected. If a determination is made that the threat is not detected, the operations can include triggering termination of the monitoring and deletion of the video. If a determination is made that the threat is detected, the operations can include triggering delivery of an alert to another device.

In some embodiments, the computer-executable instructions, when executed by the processor, cause the processor to perform operations further including determining, during the monitoring, that the monitoring has not been deactivated; determining, during the monitoring, that the time period has lapsed; and analyzing the video in response to determining that the time period has lapsed without the monitoring being deactivated. In some embodiments, the video can be analyzed at the edge device by applying, to the video, machine learning and artificial intelligence to determine if the threat is detected.

In some embodiments, detecting the monitoring trigger can include detecting selection, at the user device, of a control to begin monitoring of the user device. In some embodiments, detecting the monitoring trigger can include detecting selection, at the user device, of a control to begin monitoring of the user device after the time period if the monitoring is not deactivated before the time period lapses; determining that the time period lapsed; and determining that the monitoring was not deactivated before the time period lapsed. In some embodiments, determining that the monitoring has been deactivated can include determining that an explicit request to deactivate the monitoring has been received from the user device. In some embodiments, determining that the monitoring has been deactivated can include detecting initiation of a network connection between the user device and another device.

Other systems, methods, and/or computer program products according to embodiments will be or become apparent to one with skill in the art upon review of the following drawings and detailed description. It is intended that all such additional systems, methods, and/or computer program products be included within this description and be within the scope of this disclosure.

### BRIEF DESCRIPTION OF THE DRAWINGS

FIG. 1 is a system diagram illustrating an illustrative operating environment for various embodiments of the concepts and technologies described herein.

FIG. 2 is a flow diagram showing aspects of a method for triggering monitoring and delivery of alerts using a monitoring service, according to an illustrative embodiment of the concepts and technologies described herein.

FIG. 3 is a flow diagram showing aspects of a method for detecting a monitoring event using a monitoring service, according to an illustrative embodiment of the concepts and technologies described herein.

FIG. 4 is a flow diagram showing aspects of a method for delivering and cancelling alerts using a monitoring service, according to an illustrative embodiment of the concepts and technologies described herein.

FIG. 5 schematically illustrates a network, according to an illustrative embodiment of the concepts and technologies described herein.

FIG. 6 is a block diagram illustrating an example computer system configured to provide and/or interact with a monitoring service, according to some illustrative embodiments of the concepts and technologies described herein.

FIG. 7 is a block diagram illustrating an example mobile device configured to interact with a monitoring service, according to some illustrative embodiments of the concepts and technologies described herein.

FIG. 8 is a diagram illustrating a computing environment capable of implementing aspects of the concepts and technologies disclosed herein, according to some illustrative embodiments of the concepts and technologies described herein.

### DETAILED DESCRIPTION

The following detailed description is directed to providing and using a monitoring service. A user or other entity associated with a device (e.g., a smartphone, a gateway, a computer, a vehicle, or other device) can register for and/or sign up for features associated with a monitoring service. In some embodiments, the registration process can include opting-in for monitoring and/or installation of a monitoring application. In some other embodiments, the monitoring application can be built into the operating system and/or other applications installed and/or hosted by the user device. The monitoring application can be configured to monitor activities and/or tasks occurring at, near, and/or with the user device. The monitoring application also can be configured to capture various types of information and/or data at various times. The captured data can include contextual data that can describe tasks occurring at or near the user device; event and/or trigger data, geolocation data that indicates a location of the user device; connection data that identifies one or more active or available network connections at the user device; streaming data such as video, audio, sensor readings, or the like; and/or other data. In some embodiments, other devices at or in proximity to the user device can also be configured to capture these and/or other data. The captured data can be provided by the user device and/or the other devices to a monitoring service.

According to various implementations of the concepts and technologies disclosed herein, the monitoring service can be executed and/or hosted by a server computer, an edge device, and/or other devices or entities. The monitoring service also can be configured to obtain one or more user models in some embodiments, where the user models can describe trends and/or histories associated with tasks or operations performed at the user device and/or various aspects of these tasks or operations such as frequency, duration, etc. The monitoring service also can be configured to obtain other information from one or more data sources such as crime reporting devices, news reporting devices, social networking entities, network monitoring devices, etc. Thus, the other information can include crime reports, news reports, events, alerts, social networking information, combinations thereof, or the like.

The monitoring service can be configured to determine, e.g., based on the captured data, the user models, the other information, and/or other considerations, if monitoring of the user device is to be initiated. The determination to initiate monitoring of the user device also can be made by receiving an explicit request for monitoring from the user device and/or other entities such as the data sources and/or the other devices. When a decision is made to initiate monitoring, the monitoring service can determine a duration of the monitoring and generate one or more commands (or trigger generation of the commands). In some embodiments, a timer job can be initiated for the determined time duration when monitoring is commenced, and expiration of the timer job can trigger termination of the monitoring and/or other operations. The monitoring service also can be configured to trigger delivery of the one or more commands, where the commands can include computer-executable code that, when executed by a device that receives the commands, causes the device to initiate monitoring of the user device.

Monitoring of the user device can include streaming various types of data (e.g., as part of one or more releases and/or iterations of the captured data) to the monitoring service (e.g., executed at the server computer and/or the edge device). In some embodiments, the streamed data (e.g., video, audio, location data, sound data, bearing data, orientation data, sensor readings, etc.) can be provided to the edge device for analysis. The edge device and/or other entities can be configured to analyze the streamed data and determine, e.g., via application of machine learning logic and/or artificial intelligence, if there exists a security and/or safety threat. If a threat is detected, one or more devices can be configured to generate one or more alerts to prompt the sending of assistance to the user device. If no threat is detected, the monitoring service can be configured to delete copies of the streamed data (e.g., the stream file) to preserve privacy of the user and/or for other reasons. If it is determined that a threat has ended, alerts can be cancelled in some embodiments.

While the subject matter described herein is presented in the general context of program modules that execute in conjunction with the execution of an operating system and application programs on a computer system, those skilled in the art will recognize that other implementations may be performed in combination with other types of program modules. Generally, program modules include routines, programs, components, data structures, and other types of structures that perform particular tasks or implement particular abstract data types. Moreover, those skilled in the art will appreciate that the subject matter described herein may be practiced with other computer system configurations, including hand-held devices, multiprocessor systems, microprocessor-based or programmable consumer electronics, minicomputers, mainframe computers, and the like.

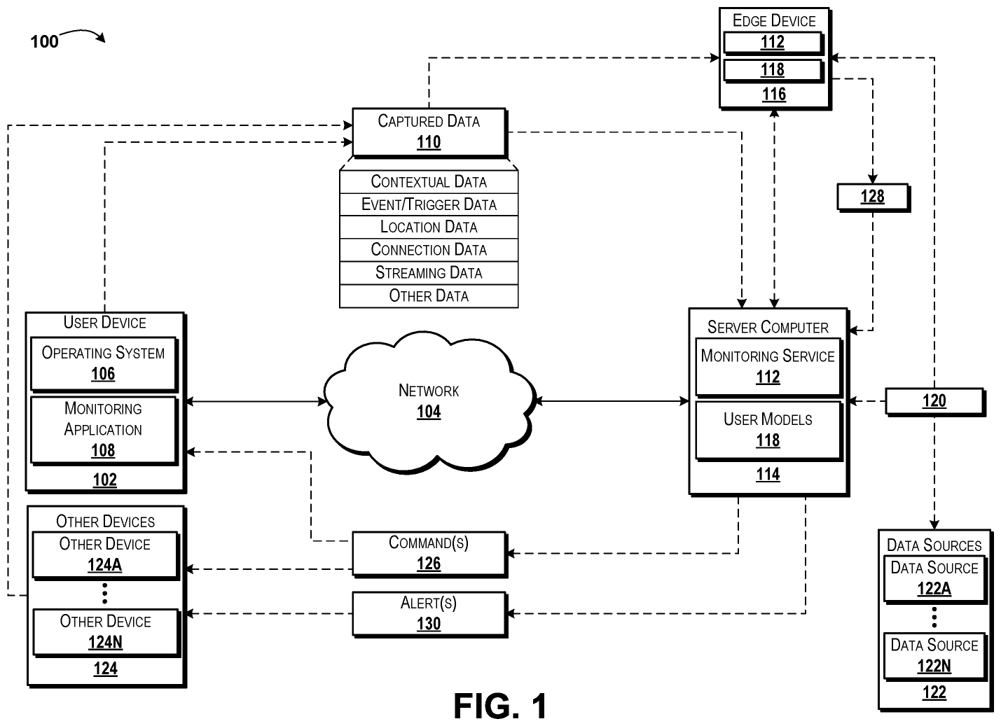

Referring now to FIG. 1, aspects of an operating environment 100 for various embodiments of the concepts and technologies disclosed herein for providing and using a monitoring service will be described, according to an illustrative embodiment. The operating environment 100 shown in FIG. 1 includes a user device 102. The user device 102 can operate in communication with and/or as part of a communications network (“network”) 104, though this is not necessarily the case in all embodiments of the concepts and technologies disclosed herein.

According to various embodiments, the functionality of the user device 102 may be provided by one or more server computers, desktop computers, mobile telephones, smartphones, laptop computers, gateway devices, other computing systems, and the like. It should be understood that the functionality of the user device 102 may be provided by a single device, by two or more similar devices, and/or by two or more dissimilar devices. For purposes of describing the concepts and technologies disclosed herein, the user device 102 is described herein as a mobile phone or smartphone. It should be understood that this embodiment is illustrative, and should not be construed as being limiting in any way.

The user device 102 can execute an operating system 106 and one or more application programs such as, for example, a monitoring application 108. The operating system 106 can include a computer program that can control the operation of the user device 102. The monitoring application 108 can include an executable program that can be configured to execute on top of the operating system 106 to provide various functions as illustrated and described herein for interacting with and/or using a monitoring service.

The monitoring application 108 can be configured to monitor activity associated with the user device 102 and/or to capture data relating to the user device 102, the user associated with the user device 102, and/or conditions in an area that is proximate to the user device 102. As used herein, the phrase “in proximity to,” “proximate to,” variations thereof, or the like can be used to refer to a physical location around the user device 102 (e.g., a room within which the user device 102 is located, a building within which the user device 102 is located, a vehicle within which the user device 102 is located, an area within which the user device 102 is located, or the like). In some embodiments, an area proximate to the user device 102 can include any physical location within a five, ten, or twenty foot radius of the user device 102, or the like. Because proximity can be defined in additional and/or alternative manners, it should be understood that these examples are illustrative, and therefore should not be construed as being limiting in any way.

The monitoring application 108 can be configured to enable the capture of geographic location information (e.g., GPS coordinates), user biometrics and/or physical state information (e.g., heart rate, blood pressure, fingerprints, etc.), environmental state information (e.g., temperature, noise levels, air pressure, light levels, etc.), and/or other information associated with an environment or proximity of the user device 102 (e.g., users or devices in the area, movements to the user device 102, etc.). In some embodiments of the concepts and technologies disclosed herein, the user device 102 can communicate with various devices (e.g., smart watches, other user devices, etc.) to determine and/or obtain these and/or other metrics associated with the user of the user device 102 and/or the environment around the user device 102. It should be understood that this example is illustrative, and therefore should not be construed as being limiting in any way.

According to various embodiments of the concepts and technologies disclosed herein, the user device 102 can include a camera and a microphone, which can collectively enable the capture (by the user device 102 using the monitoring application 108) of audio and video in the area around the user device 102. It should be understood that this example is illustrative, and therefore should not be construed as being limiting in any way. The monitoring application 108 also can be configured to capture context information associated with the user device 102 such as, for example, information that indicates how the user device 102 is being used, a destination of the user device 102 if moving, tasks and/or functions being completed by the user device 102 in the foreground or background, combinations thereof, or the like.

Although not shown in FIG. 1, the monitoring application 108 also can be configured to create and/or store one or more models of behavior associated with the user device 102 and/or users of the user device 102. These models of behavior can be stored locally at the user device 102 and used, in some embodiments, to understand activity associated with the user device 102. Specifically, the models of behavior can be used to identify or determine patterns of use associated with the user device 102 and/or a user of the user device 102, times to complete tasks associated with the user device 102 and/or a user of the user device 102, movements (e.g., direction of travel, speed of travel, orientation of the user device 102 during travel, etc.) associated with the user device 102 and/or a user of the user device 102, combinations thereof, or the like.

According to various embodiments of the concepts and technologies disclosed herein, the user device 102 can capture (e.g., via the monitoring application 108) various types of information as captured data 110. As shown in FIG. 1, the captured data 110 can include contextual data, event and/or trigger data, location data, connection data, streaming data, other data, combinations thereof, or the like.

The contextual data can define one or more operations or activities being completed or performed by the user device 102 such as, for example, applications executing at the user device 102, data communications occurring at the user device 102, media use occurring via the user device 102, and/or other operations being performed at, with, and/or using the user device 102. Thus, the contextual data can define how the user device 102 is being used and/or for what purposes the user device 102 is being used at a particular time. The monitoring application 108 can be configured to monitor use of the user device 102 and to generate the contextual data, in some embodiments. In some other embodiments, external devices (e.g., monitors, applications, services, combinations thereof, or the like) can be configured to determine the contextual data at one or more times. In some embodiments of the concepts and technologies disclosed herein, the contextual data can be obtained over time and trends and/or histories can be generated by the monitoring application 108 and/or a monitoring service 112. It should be understood that these example embodiments are illustrative, and therefore should not be construed as being limiting in any way.

The event and/or trigger data can describe one or more events or triggers, for example events or triggers for monitoring. In some embodiments of the concepts and technologies disclosed herein, the event and/or trigger data can indicate, for example, that a particular button (hard or soft) has been activated at the user device 102. Activation of this particular hard or soft button (e.g., a panic button) can indicate, to the monitoring application 108 or the like, that monitoring of the user device 102 is requested, desired, or should be activated. By way of example, a user may activate the particular button when feeling unsafe for some reason, and the event and/or trigger data can indicate that this activation has occurred. Thus, the event and/or trigger data can indicate that monitoring has been explicitly requested at, by, and/or via the user device 102. It should be noted that in some embodiments of the concepts and technologies disclosed herein, the trigger and/or event data (or equivalents thereof) can be generated by one or more other sources, as will be illustrated and described in more detail hereinbelow. As such, it should be understood that the illustrated example of the captured data 110, where the user device 102 generates the event and/or trigger data, is illustrative of one embodiment of the concepts and technologies disclosed herein and therefore should not be construed as being limiting in any way.

The location data can define or describe a geographic location of the user device 102 at a particular time (or at multiple times). Thus, for example, the location data can include GPS coordinates or other data that can describe a geographic location of the user device 102. In some embodiments, for example, the location data can include identification of a location beacon, wireless router or other networking data (e.g., an SSID or the like), combinations thereof, or the like, which may be used to determine or identify location. The captured data 110 therefore can include data that identifies a location of the user device 102 directly or indirectly. At any rate, the location data can be used to trigger monitoring, to track the location of the user device 102 during monitoring, and/or as a trigger to terminate the monitoring, in some embodiments. It should be understood that this example is illustrative, and therefore should not be construed as being limiting in any way.

The connection data can identify one or more network connections associated with the user device 102 and/or one or more network connections between the user device 102 and other devices that may be proximate to the user device 102 (e.g., other user devices in the area, wireless networking hardware, automobile connections, combinations thereof, or the like). Thus, the connection data can be used to determine if one or more other entities are in proximity to the user device 102 and/or what devices and/or entities the user device 102 is near, within a communication range of, and/or to which the user device 102 is connected. It should be understood that this example is illustrative, and therefore should not be construed as being limiting in any way.

The streaming data can include various types of information and/or data that can be captured at the user device 102 and/or one or more devices in communication with the user device 102 such as wearables, health devices, cameras, temperature sensors, pressure sensors, light sensors, networking equipment, automobiles, motion sensors, gyroscopes, accelerometers, magnetometers, combinations thereof, or the like. According to various embodiments of the concepts and technologies disclosed herein, the streaming data can include streaming video, streaming audio, streaming sensor data (e.g., temperature data, light levels, pressure levels, orientation and/or movement information, bearing information, etc.), location data, other information, combinations thereof, or the like. These and/or other streaming data can be provided as part of the monitoring to one or more entities as will be illustrated and described in more detail herein. Because other types of information and/or data can be captured and/or streamed in accordance with various embodiments of the concepts and technologies disclosed herein, it should be understood that these examples of the stream data are illustrative, and therefore should not be construed as being limiting in any way.

The other data can include other information that may be captured by the user device 102 such as, for example, a user identity associated with the user device 102, orientation and/or movement information associated with the user device 102, environmental conditions (e.g., temperature, air pressure, light levels, noise levels, etc.) in a proximity of the user device 102, biometric information captured by the user device 102 (e.g., heart rate of a user of the user device 102, fingerprints or other identifying information associated with a user of the user device 102, combinations thereof, or the like). Thus, the other data can include any data that is described herein as being captured by the user device 102 for use in providing and/or using a monitoring service 112 as illustrated and described herein. It should be understood that this example is illustrative, and therefore should not be construed as being limiting in any way.

The captured data 110 can be provided by the user device 102 to the monitoring service 112, which can be executed and/or hosted by a device such as the server computer 114 and/or other devices such as, for example, an edge device 116. In some embodiments of the concepts and technologies disclosed herein, the functionality of the server computer 114 can be provided by the edge device 116 instead of the server computer 114. As such, it should be understood that the monitoring service 112 can be executed and/or hosted by the server computer 114, the edge device 116, other devices, and/or a combination thereof. As such, it should be understood that the illustrated embodiment is illustrative and should not be construed as being limiting in any way.

According to various embodiments of the concepts and technologies disclosed herein, the server computer 114 and/or the edge device 116 also can be configured to store and/or access one or more user models 118. The user models 118 can model behavior of one or more users and/or user devices such as the user device 102. These user models 118 can define, for example, trends and/or historical data reflecting movements of the user device 102, expected travel times associated with the user device 102 and/or specific tasks performed with the user device 102, and/or other information that can reflect usage of the user device 102. Thus, for example, the user models 118 can define, for a particular user or user device 102, a time at which the user walks to his or her car, an expected walking time for that trip, locations associated with that trip, etc. These and/or other information can be used to determine when a particular activity is occurring with the user device 102, an expected time (e.g., time of day, date, and duration) at which and/or for which that activity will occur, combinations thereof, or the like. These and/or other behavior of the user and/or user device 102 can be used to determine when an expected behavior or event does not occur as expected (e.g., the event or operation takes more time than expected, failed to commence at the time expected, failed to end at the time expected, etc.). As will be explained in more detail below, such events can trigger monitoring and/or be used to trigger monitoring as illustrated and described herein.

In various embodiments, and as shown in FIG. 1, other types of information (“other information”) 120 can be captured by one or more data sources 122A-N (hereinafter collectively and/or generically referred to as “data sources 122”). The other information 120 can be provided by the data sources 122 to the monitoring service 112 (e.g., at the server computer 114 and/or the edge device 116). According to various embodiments of the concepts and technologies disclosed herein, the other information 120 can include contextual data, event and/or trigger data, location data, connection data, and/or other data (which, in some embodiments, can be similar and/or even identical to these aspects of the captured data 110 illustrated and described hereinabove) associated with the user device 102 and/or one or more other devices 124A-N (hereinafter collectively and/or generically referred to as “other devices 124”). The other devices 124 can include other user devices (e.g., user devices in proximity to, in communication with, and/or in the same area as the user device 102). Thus, while the other devices 124 and the data sources 122 are illustrated as different entities, it should be understood that the other devices 124 can be included in the data sources 122 in some embodiments.

According to various embodiments, the other information 120 can include crime reports; event monitor output; trigger data based on suspicions raised by other users in the area of the user device 102 or elsewhere (e.g., online connections, social networks, etc.); triggers and/or events resulting from users in a social network of a user associated with the user device 102; and/or other information that may be used to activate and/or deactivate the monitoring illustrated and described herein. In some embodiments, for example, the user device 102 may be streaming a live video stream over a social networking service to a social network that includes a user of the user device 102. A member of the social network may see something in the live video stream that raises a safety concern and the member of the social network may activate an alarm, alert, or other trigger that can be provided to the server computer 114 as the other information 120. It should be understood that this example is illustrative, and therefore should not be construed as being limiting in any way.

The monitoring service 112 can be configured to obtain the captured data 110, one or more user models 118, and/or the other information 120. The monitoring service 112 can be configured to analyze these and/or other data to determine if a potential security or safety issue exists for the user device 102 and/or a user thereof. If such a security or safety issue is determined to exist, the monitoring service 112 can be configured to determine that monitoring of the user device 102 (and/or a user thereof) should be activated (if not yet activated), that alerting or warning should be initiated, that first responders or others should be contacted, etc. In some embodiments, monitoring may be initiated without any known threat. In response to a determination that monitoring should be initiated, the monitoring service 112 can be configured to identify or determine a time period for the monitoring. The time period can be determined, in some embodiments, based on the activity occurring (e.g., which can be determined in some embodiments by the contextual data, the user models 118 and/or other information), location data, and/or other data such as the captured data 110 and/or the other information 120. The monitoring service 112 can trigger the monitoring and define an amount of time for which the monitoring should occur.

In various embodiments of the concepts and technologies disclosed herein, the monitoring service 112 can trigger the monitoring by generating one or more commands 126 and delivering the commands 126 to the user device 102, the other devices 124, and/or other entities. The commands 126 can include computer-executable code that, when executed by the user device 102, the other devices 124, and/or other entities, causes the user device 102, other device 124, and/or other entity to monitor the surroundings of the user device 102 (e.g., by activating cameras, audio devices (e.g., microphones), or the like) and/or the user of the user device 102. The monitoring can include, for example, causing one or more devices to stream data such as, for example, video, audio, biometric data, environmental conditions data, sensor data, and/or other information (“streaming data”) to the server computer 114 and/or the edge device 116. In some embodiments, for example, the streaming data can be provided by the user device 102 and/or the other devices 124 to the edge device 116 and/or the server computer 114 (e.g., as part of the captured data 110). It should be understood that this example is illustrative, and therefore should not be construed as being limiting in any way.

In various embodiments of the concepts and technologies disclosed herein, the user device 102 and/or the other devices 124 can be configured to send the streaming data (e.g. as part of the captured data 110 and/or separately) to the edge device 116. The edge device 116 can be configured to store the streaming data during the monitoring, in some embodiments. In some embodiments, the monitoring service 112 can be executed by the edge device 116 to analyze the streaming data during the streaming, for example by using machine learning and/or artificial intelligence. The analyzing can be completed to determine if any potential security or safety threats are detected in the streaming data. If the monitoring is completed without any potential safety or security threats being detected in the streaming data, the edge device 116 can be configured to stop the monitoring and/or to delete all stored versions of the streaming data, in some embodiments. It should be understood that this example is illustrative, and therefore should not be construed as being limiting in any way.

If a potential security or safety threat is detected in the streaming data before or after the monitoring is completed, the edge device 116 can be configured to take action on the potential security or safety threat. In some embodiments, the edge device 116 can be configured to take action by providing a file that includes a copy of the streaming data (“stream file”) 128 to the server computer 114. The server computer 114 can be configured in some embodiments to generate one or more alerts 130 or to take other actions. The alerts 130 can be delivered to one or more other devices 124 for action. In some embodiments, for example, the other devices 124 can correspond to a police or other first responder device, and the alert 130 can be configured to summon the first responder to a location associated with the user device 102. In some embodiments, the edge device 116 can generate the alerts 130 illustrated and described herein and/or deliver the alerts 130 to the other devices 124. It should be understood that this example is illustrative, and therefore should not be construed as being limiting in any way.

In practice, a user or other entity associated with the user device 102 can register for, sign up for, and/or otherwise obtain features associated with the monitoring service 112. In some embodiments, the registration process can include opting-in for monitoring and/or installation of the monitoring application 108. In some other embodiments, the monitoring application 108 can be built into the operating system 106 and/or other applications installed and/or hosted by the user device 102. The monitoring application 108 can be configured to monitor activities and/or tasks occurring at or with the user device 102 and to capture various types of information and/or data at various times. The captured data 110 can include contextual data that can describe tasks occurring at or near the user device 102; event and/or trigger data, geolocation data that indicates a location of the user device 102; connection data that identifies one or more active or available network connections at the user device 102; streaming data such as video, audio, sensor readings, or the like; and/or other data. In some embodiments, other devices 124 at or in proximity to the user device 102 can also be configured to capture these and/or other data. The captured data 110 can be provided by the user device 102 and/or the other devices 124 to a monitoring service 112.

According to various implementations of the concepts and technologies disclosed herein, the monitoring service 112 can be executed and/or hosted by a server computer 114, an edge device 116, and/or other devices or entities. The monitoring service 112 also can be configured to obtain one or more user models 118 in some embodiments, where the user models 118 can describe trends and/or histories associated with tasks or operations performed at user device 102 and/or various aspects of these tasks or operations such as frequency, duration, etc. The monitoring service 112 also can be configured to obtain other information 120 from one or more data sources 122 such as crime report devices, news report devices, social networking entities, network monitoring devices, etc. Thus, the other information can include crime reports, news reports, events, alerts, social networking information, combinations thereof, or the like.

The monitoring service can be configured to determine, e.g., based on the captured data 110, the user models 118, the other information 120, and/or other considerations, if monitoring of the user device 102 is to be initiated. The determination to initiate monitoring of the user device 102 also can be made by receiving an explicit request for monitoring from the user device 102 and/or other entities such as the data sources 122 and/or the other devices 124. When a decision is made to initiate monitoring, the monitoring service 112 can determine a duration of the monitoring and generate one or more commands 126 (or trigger generation of the commands 126) that can trigger the monitoring. In some embodiments, a timer job can be initiated for the determined time duration when monitoring is commenced, and expiration of the timer job can trigger termination of the monitoring, escalation, analysis of the streamed data, and/or other operations. The monitoring service 112 also can be configured to trigger delivery of the one or more commands 126, where the commands 126 can include computer-executable code that, when executed by a device that receives the commands 126, causes the device to initiate monitoring of the user device 102.

Monitoring of the user device 102 can include streaming data (e.g., as part of one or more releases, streams, and/or iterations of the captured data) to the monitoring service 112 (e.g., executed at the server computer 114 and/or the edge device 116). In some embodiments, streamed data can be provided to the edge device 116 for analysis. The edge device 116 and/or other entities can be configured to analyze the streamed data (e.g., video, audio, sensor readings, etc.) and determine, e.g., via application of machine learning logic and/or artificial intelligence, if there exists a security and/or safety threat. If a threat is detected, one or more devices can be configured to generate one or more alerts 130 to prompt the sending of assistance to the user device 102 and/or to prompt other actions. If no threat is detected, copies of the streamed data (e.g., the stream file 128) can be deleted to preserve privacy of the user. If it is determined that a threat has ended, alerts 130 can be cancelled in some embodiments. It should be understood that this example is illustrative, and therefore should not be construed as being limiting in any way.

FIG. 1 illustrates one user device 102, one network 104, one server computer 114, one edge device 116, multiple data sources 122, and multiple other devices 124. It should be understood, however, that various implementations of the operating environment 100 can include zero, one, or more than one user device 102; zero, one, or more than one network 104; zero, one, or more than one server computer 114; zero, one, or more than one edge device 116; zero, one, or more than one data sources 122; and/or zero, one, or more than one other devices 124. As such, the illustrated embodiment should be understood as being illustrative, and should not be construed as being limiting in any way.

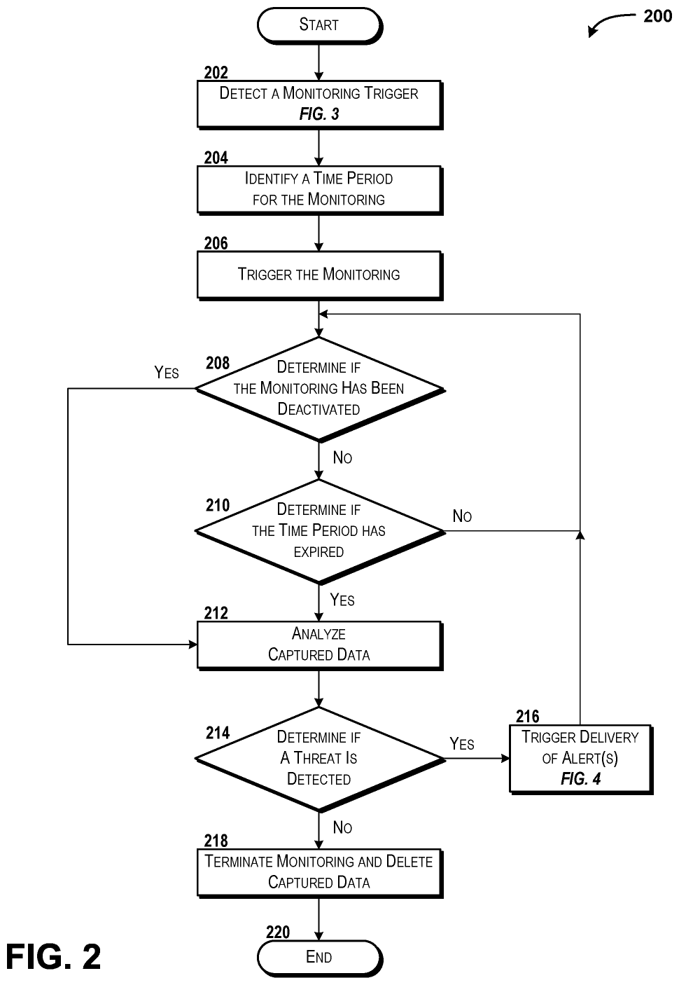

Turning now to FIG. 2, aspects of a method 200 for triggering monitoring and delivery of alerts 130 using a monitoring service 112 will be described in detail, according to an illustrative embodiment. It should be understood that the operations of the methods disclosed herein are not necessarily presented in any particular order and that performance of some or all of the operations in an alternative order(s) is possible and is contemplated. The operations have been presented in the demonstrated order for ease of description and illustration. Operations may be added, omitted, and/or performed simultaneously, without departing from the scope of the concepts and technologies disclosed herein.

It also should be understood that the methods disclosed herein can be ended at any time and need not be performed in its entirety. Some or all operations of the methods, and/or substantially equivalent operations, can be performed by execution of computer-readable instructions included on a computer storage media, as defined herein. The term “computer-readable instructions,” and variants thereof, as used herein, is used expansively to include routines, applications, application modules, program modules, programs, components, data structures, algorithms, and the like. Computer-readable instructions can be implemented on various system configurations including single-processor or multiprocessor systems, minicomputers, mainframe computers, personal computers, hand-held computing devices, microprocessor-based, programmable consumer electronics, combinations thereof, and the like.

Thus, it should be appreciated that the logical operations described herein are implemented (1) as a sequence of computer implemented acts or program modules running on a computing system and/or (2) as interconnected machine logic circuits or circuit modules within the computing system. The implementation is a matter of choice dependent on the performance and other requirements of the computing system. Accordingly, the logical operations described herein are referred to variously as states, operations, structural devices, acts, or modules. These states, operations, structural devices, acts, and modules may be implemented in software, in firmware, in special purpose digital logic, and any combination thereof. As used herein, the phrase “cause a processor to perform operations” and variants thereof is used to refer to causing a processor of a computing system or device, such as the server computer 114 or the edge device 116, to perform one or more operations and/or causing the processor to direct other components of the computing system or device to perform one or more of the operations.

For purposes of illustrating and describing the concepts of the present disclosure, the method 200 is described herein as being performed by the server computer 114 via execution of one or more software modules such as, for example, the monitoring service 112. It should be understood that additional and/or alternative devices and/or network nodes can provide the functionality described herein via execution of one or more modules, applications, and/or other software including, but not limited to, the monitoring service 112. In particular, in some embodiments the functionality illustrated and described herein can be performed by the edge device 116 via execution of one or more software modules such as, for example, the monitoring service 112. As such, the illustrated embodiment should be understood as being illustrative, and should not be viewed as being limiting in any way.

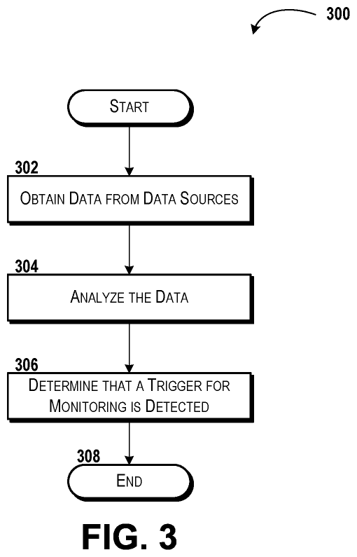

The method 200 begins at operation 202. At operation 202, the server computer 114 can detect a monitoring trigger. As illustrated and described herein, the monitoring trigger can be received from the user device 102, the data sources 122, the other devices 124, and/or other entities. Thus, the monitoring trigger detected in operation 202 can be determined based on the captured data 110, the other information 120, the user models 118, an explicit request to monitor, and/or other information. Additional details of detecting a monitoring trigger will be illustrated and described in more detail herein with reference to FIG. 3.

From operation 202, the method 200 can proceed to operation 204. At operation 204, the server computer 114 can identify a time period for the monitoring. According to various embodiments of the concepts and technologies disclosed herein, the server computer 114 can determine the time period based on analysis of the user models 118, the captured data 110, and/or the other information 120. Thus, for example, the monitoring service 112 can determine that a user of the user device 102 is beginning a walk from an office to a car and a time period expected to be associated with the walk to the car. This time period can be based, in some embodiments, on an amount of time the user previously walked when leaving the office to go the car. In some embodiments, the time duration begins at a current time, while in some other embodiments, the time of the monitoring can be set in the future for a duration. It should be understood that these examples are illustrative, and therefore should not be construed as being limiting in any way.

In some other embodiments, operation 204 can include detecting that a soft or hard button (e.g., a panic button) has been selected at or via the user device 102, and a time period for which monitoring associated with selection of the button is to be performed. In some embodiments, for example, the monitoring can be performed for a set duration such as one minute, five minutes, ten minutes, fifteen minutes, one hour, or the like. Thus, operation 204 can correspond to the server computer 114 detecting selection of an option to monitor the user device 102 and determination of a time period for which the monitoring is to last. It should be understood that in some embodiments, selection of an option to monitor the user device 102 can include obtaining from a user or other entity a time period for which the monitoring is to last (e.g., a first screen display can offer an option to monitor the user device 102 and a second screen display can be presented to enable a user or other entity to select or specify a time for which the monitoring will last). It should be understood that this example is illustrative, and therefore should not be construed as being limiting in any way.

Thus, operation 204 can include determining an operation or action that is occurring (e.g., based on the contextual data, event and/or trigger data, selection of an option to monitor the user device 102, etc.) and determination of a time period for which the monitoring will last, wherein the time period can be set by preferences, selections of users or other entities, determination of how long a particular action or activity is expected to last, user and/or device histories, input from users or other entities, etc. Thus, while not illustrated separately in operation 204, the server computer 114 can determine a time period for monitoring in a number of manners. It should be understood that these examples are illustrative, and therefore should not be construed as being limiting in any way.

From operation 204, the method 200 can proceed to operation 206. At operation 206, the server computer 114 can trigger the monitoring. In operation 206, the server computer 114 can generate and/or provide to one or more devices, such as the user device 102 and/or the other devices 124, a command 126. The command 126 can include computer-executable code that, when executed by the user device 102 and/or the other devices 124, can cause the user device 102 and/or the other devices 124 to initiate monitoring of the user device 102. It can be appreciated that in some embodiments, for example, where an explicit request to monitor is created or triggered at the user device 102, the monitoring application 108 can trigger the monitoring locally and therefore commands 126 may not be required. In various embodiments, the monitoring can include initiating capturing and streaming of streaming data including, but not limited to, video, audio, environmental conditions, sensor readings, movement and/or orientation data, location data, combinations thereof, or the like.

In some embodiments, the user device 102 can initiate streaming of video and audio to one or more devices such as the server computer 114 and/or the edge device 116 as part of the monitoring. In some other embodiments, the streaming video and/or audio can be accompanied by data that specifies a temperature, ambient light level, sound levels, movements, orientations, bearings, locations, sensor readings, and/or the like associated with the user device 102 and/or an environment in which the user device 102 is located. As noted above, the other devices 124 can be configured to initiate streaming of video, audio, and/or other data as illustrated and described herein instead of, or in addition to, the user device 102. Thus, the user and/or the user device 102 can be monitored, in some embodiments, by viewing and/or analyzing the streamed data by another device, user, or entity. In some embodiments, as illustrated and described herein, the streaming data can be analyzed, for example by one or more machine learning and/or artificial intelligence entities, to detect potential or actual security or safety threats. It should be understood that this example is illustrative, and therefore should not be construed as being limiting in any way.

From operation 206, the method 200 can proceed to operation 208. At operation 208, the server computer 114 can determine if the monitoring has been deactivated, stopped, or otherwise ended. In some embodiments of the concepts and technologies disclosed herein, the monitoring can be stopped by a user, for example by issuing (e.g., via selection of an option at the user device 102) an explicit request to deactivate or terminate the monitoring. In some other embodiments, the monitoring can be stopped by an application, service, or other entity based on review of streaming data, based on other information (e.g., determining that the user is safe and/or in a different location), or the like. In yet other embodiments, for example, the monitoring trigger may specify a task and an expected time to complete the task and the monitoring therefore can be terminated after the expected time.

In yet other embodiments, if the expected time to complete the task is completed without detecting completion of the task or deactivation of the monitoring, the server computer 114 can determine that the monitoring has not been stopped or ended and this can trigger additional actions. Similarly, the monitoring can be deactivated by certain events tied to the tasks, in some embodiments. For example, the task that triggered the monitoring can include walking to a car, in some embodiments. If the server computer 114 detects a connection between the user device 102 and the car (e.g., in an instance of the connection data included in an instance of the captured data 110), the server computer 114 can trigger the termination of the monitoring. Thus, operation 208 can correspond to determining if some explicit command has been issued by a user or other entity to terminate the monitoring, if some other event has terminated the monitoring, or the like. It should be understood that this example is illustrative, and therefore should not be construed as being limiting in any way.

If the server computer 114 determines in operation 208 that the monitoring has not been deactivated, the method 200 can proceed to operation 210. At operation 210, the server computer 114 can determine if the time period identified or set in operation 204 has expired. In some embodiments, the time period can be used to prompt an alert 130 or other response if the monitoring is not deactivated before the time period expires. In some embodiments, operation 208 can correspond to determining if a timer job, e.g., a timer set when monitoring began, has expired. For example, if a time period for the monitoring set in operation 204 corresponds to a time of x minutes, a timer job can be initiated for x minutes and operation 210 can correspond to detecting the expiration of the timer job (and lapsing of the x minutes). It should be understood that this example is illustrative, and therefore should not be construed as being limiting in any way.

It should be understood that in some embodiments of the concepts and technologies disclosed herein a time period for the monitoring may not be set, and that monitoring can continue until deactivated by a user, application, service, or other entity. As such, some embodiments of the method 200 can omit the operation 210. If the server computer 114 determines in operation 210 that the time period has not expired, flow of the method 200 can return to operation 208. Thus, it can be appreciated that operations 208-210 can be iterated in some embodiments until the server computer 114 determines, in any iteration of operations 208 or 210 that the monitoring has been deactivated (operation 208) or that the time period has expired (operation 210).

If the server computer determines, in any iteration of operation 210, that the time period has expired, flow of the method 200 can proceed to operation 212. Flow of the method 200 also can proceed to operation 212 if the server computer 114 determines at operation 208 that the monitoring has been deactivated, ended, or otherwise is to be terminated. At operation 212, the server computer 114 can analyze captured data (e.g., data obtained through the monitoring triggered in operation 206 such as the stream file 128 shown in FIG. 1). According to various embodiments of the concepts and technologies disclosed herein, the analysis of the captured data 110 can occur at the edge device 116, so the illustrated embodiment of the method 200 is illustrative and should not be construed as being limiting in any way.

The server computer 114 (or the edge device 116) can be configured to apply, to the captured data 110 and/or the stream file 128, one or more machine learning and/or artificial intelligence models and/or algorithms to detect, in the captured data 110 and/or stream file 128, a potential security or safety threat. The analysis of operation 212 also can include converting observed language (e.g., voices, etc.) to text and performing natural language analysis on the text. The analysis of operation 212 also can include determining if expected time periods for tasks (e.g., walking from a first location to a second location) has met an expectation or not. In some embodiments, the analysis of operation 212 can include detecting people in video and monitoring movements of those people to detect, e.g., via body language, facial expressions, and/or other clues, if any perceived security or safety threat exists. In some other embodiments, the captured data 110 may be streamed to a social network and operation 212 can correspond to detecting, e.g., via analysis of comments or responses to the streaming of the captured data 110 to the social network, that a security or safety threat exists. Thus, in some embodiments of the concepts and technologies disclosed herein security and/or safety threats may be detected as the result of crowd-sourced reactions to the streaming of the captured data 110. Because other types of analysis can be performed in operation 212, it should be understood that these examples are illustrative, and therefore should not be construed as being limiting in any way.

From operation 212, the method 200 can proceed to operation 214. At operation 214, the server computer 114 can determine if a threat is detected via the analysis of the captured data 110 or stream file 128 in operation 212. If the server computer 114 determines in operation 214 that a threat is detected in the captured data, the method 200 can proceed to operation 216. At operation 216, the server computer 114 can trigger delivery of one or more alerts such as the alert 130 shown in FIG. 1. The alerts (e.g., the alert 130) can include geographic location data (e.g., GPS coordinates that identify the location of the user device 102) and a description of the perceived security or safety threat, in some embodiments. It should be understood that this example is illustrative, and therefore should not be construed as being limiting in any way.

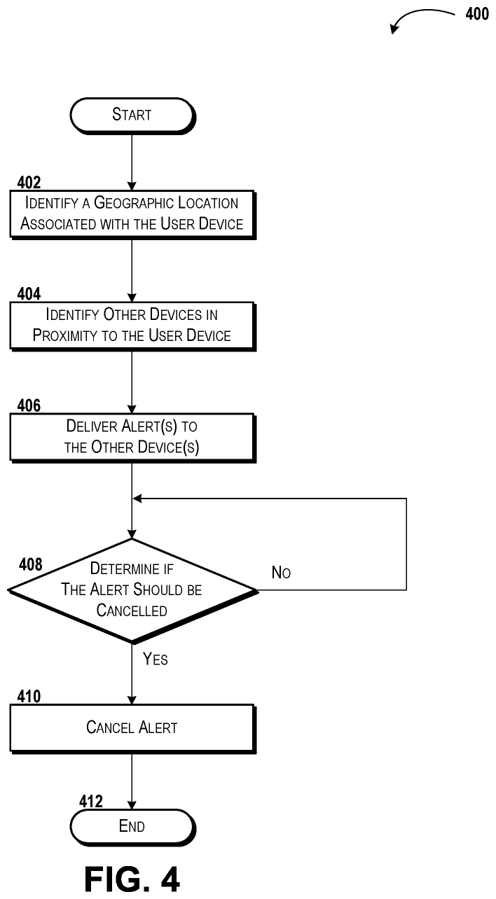

According to various embodiments of the concepts and technologies disclosed herein, the alerts 130 can be delivered to one or more devices or entities (e.g., the other devices 124 illustrated and described in FIG. 1) such as police departments, fire departments, emergency medical service entities, other first responders, or the like. In some other embodiments, the alerts 130 can be delivered to one or more user devices (e.g., the other devices 124) that may be located at or near the user device 102, thereby enabling one or more entities in the area of the user device 102. Because the alerts 130 can be delivered to additional and/or alternative entities, it should be understood that these examples are illustrative, and therefore should not be construed as being limiting in any way. Additional details of providing and/or cancelling the alerts 130 will be illustrated and described in more detail herein with reference to FIG. 4. From operation 216, the method 200 can return to operation 208 and monitoring can be re-initiated, continued, or otherwise can continue to monitor the user device 102.

If the server computer 114 determines in operation 214 that a threat is not detected in the captured data, the method 200 can proceed to operation 218. At operation 218, the server computer 114 can terminate the monitoring and delete any stored versions of the captured data 110 obtained in operation 212 such as, for example, the stream file 128 and/or any other files (e.g., precursor files such as streamed data, etc.). Thus, some embodiments of the concepts and technologies disclosed herein can help protect and/or maintain privacy of a user associated with the user device 102 by deleting any streamed data that may result from the monitoring if no threat is detected. It should be understood that this example is illustrative, and therefore should not be construed as being limiting in any way.

In some embodiments of the concepts and technologies disclosed herein, the method 200 can proceed from operation 208, if the server computer 114 determines that the monitoring has been deactivated, to operation 218 instead of proceeding to operation 212. Thus, in these embodiments of the method 200, a user deactivating the monitoring can prevent the analysis of the captured data by the server computer 114 and/or the edge device 116, and the termination of the monitoring and deletion of all captured data to maintain user privacy. As such, the illustrated embodiment of the method 200 is illustrative of one contemplated embodiment and should not be construed as being limiting in any way.

From operation 218, the method 200 can proceed to operation 220. The method 200 can end at operation 220.

Turning now to FIG. 3, aspects of a method 300 for detecting a monitoring event using a monitoring service 112 will be described in detail, according to an illustrative embodiment. It should be understood that the operations illustrated and described herein with reference to the method 300 can be performed, in some embodiments, in association with the performance of operation 202 of the method 200 illustrated and described above. It should be understood that this example is illustrative, and therefore should not be construed as being limiting in any way.

For purposes of illustrating and describing the concepts of the present disclosure, the method 300 is described herein as being performed by the server computer 114 via execution of one or more software modules such as, for example, the monitoring service 112. It should be understood that additional and/or alternative devices and/or network nodes can provide the functionality described herein via execution of one or more modules, applications, and/or other software including, but not limited to, the monitoring service 112. Thus, the illustrated embodiments are illustrative, and should not be viewed as being limiting in any way.

The method 300 begins at operation 302. At operation 302, the server computer 114 can obtain data associated with the user device 102. In various embodiments of the concepts and technologies disclosed herein, the data obtained in operation 302 can include the captured data 110 (which as noted above with reference to FIG. 1 can include contextual data, event and/or trigger data, location data, connection data, streaming data, other data, or the like), which can be provided by the user device 102 and/or one or more other devices 124. The data obtained in operation 302 also can include the other information 120 illustrated and described above with reference to FIG. 1, and therefore can include data obtained from one or more data sources 122 such as social networking devices, event monitoring devices (e.g., crime report monitors), news devices, other devices, or the like. Thus, the data obtained in operation 302 can include contextual data, location data, event and/or trigger data, connection data, streaming data, crime events, news events, an indication that a social networking user has indicated that a threat may exist, other data, combinations thereof, or the like.

From operation 302, the method 300 can proceed to operation 304. At operation 304, the server computer 114 can analyze the data obtained in operation 302. In various embodiments, the data obtained in operation 302 can be analyzed to determine if any events or triggers for monitoring are detected. In some embodiments, operation 304 can correspond to the server computer 114 detecting, in the data obtained in operation 302, an explicit trigger for the monitor such as selection of a hard or soft button at the user device 102, an event-based trigger (e.g., the user of the user device 102 embarking on a task that, when detected, triggers monitoring), a crowd-sourced trigger for monitoring (e.g., received as the other information 120), or other triggers or events that can trigger the monitoring. Because a trigger for the monitoring can be detected in additional and/or alternative manners, it should be understood that these examples are illustrative, and therefore should not be construed as being limiting in any way.

From operation 304, the method 300 can proceed to operation 306. At operation 306, the server computer 114 can determine that a trigger for the monitoring has been detected. From operation 306, the method 300 can proceed to operation 308. The method 300 can end at operation 308.

Turning now to FIG. 4, aspects of a method 400 for delivering and cancelling alerts 130 using a monitoring service 112 will be described in detail, according to an illustrative embodiment. It should be understood that the operations illustrated and described herein with reference to the method 400 can be performed, in some embodiments, in association with the performance of operation 216 of the method 200 illustrated and described above, though this is not necessarily the case. As such, it should be understood that this example is illustrative, and therefore should not be construed as being limiting in any way.

For purposes of illustrating and describing the concepts of the present disclosure, the method 400 is described herein as being performed by the server computer 114 via execution of one or more software modules such as, for example, the monitoring service 112. It should be understood that additional and/or alternative devices and/or network nodes can provide the functionality described herein via execution of one or more modules, applications, and/or other software including, but not limited to, the monitoring service 112. Thus, the illustrated embodiments are illustrative, and should not be viewed as being limiting in any way.

The method 400 begins at operation 402. As noted above, it should be understood that in some embodiments, the method 400 can be initiated upon determining that alerts should be delivered to one or more devices as illustrated and described above with reference to FIG. 2, though this is not necessarily the case. It should be understood that this example is illustrative, and therefore should not be construed as being limiting in any way.

At operation 402, the server computer 114 can identify a geographic location associated with the user device 102. According to various embodiments of the concepts and technologies disclosed herein, the geographic location associated with the user device 102 can include a location of the user device 102 (e.g., GPS coordinates or other location information identifying a location of the user device 102), a general area in which the user device 102 is located, or other broadly or narrowly defined location associated with the user device 102. In particular, in some other embodiments, the location of the user device 102 may be determined by proximity to other devices or entities (e.g., other devices 124, location beacons, or the like). In some other embodiments, the location of the user device 102 can be determined based on connection data (e.g., one or more network connections associated with the user device 102). Because the location of the user device 102 or a location associated with the user device 102 can be determined in additional and/or alternative manners, it should be understood that these examples are illustrative, and therefore should not be construed as being limiting in any way.

From operation 402, the method 400 can proceed to operation 404. At operation 404, the server computer 114 can identify other devices (e.g., the other devices 124 shown in FIG. 1) in proximity to the user device 102. In various embodiments of the concepts and technologies disclosed herein, the server computer 114 can determine the locations of the other devices, or trigger other entities such as the edge device 116, the user device 102, location servers, or the like to identify the other devices in proximity to the user device 102. According to various embodiments of the concepts and technologies disclosed herein, the other devices 124 can be determined to be in proximity to the user device 102 by determining that the other devices 124 are within a certain number of feet, meters, miles, or the like of the user device 102, or that the other devices 124 are in an area or region associated with the user device 102. Because the other devices 124 can be determined to be in proximity to the user device 102 in additional and/or alternative manners, it should be understood that these examples are illustrative, and therefore should not be construed as being limiting in any way.

According to various embodiments of the concepts and technologies disclosed herein, the distance within which another device may be determined to be “in proximity to” the user device 102 can be defined by settings, configurations, contextual information, threat level, or the like. In some embodiments, for example, the distance can vary based on the type of threat determined and/or any expected risk (or lack of expected risk) to entities associated with the other devices 124. For example, if an imminent health issue associated with a user of the user device 102 is detected, the distance can be determined as being a first distance such as one hundred feet, one mile, or the like; as it may be determined that a responding entity may have more time to help. In some examples, if a personal safety threat is detected, the distance can be determined as being a second distance that may be less than the first distance as any help that may be summoned using embodiments of the concepts and technologies disclosed herein may have comparatively less time to help avert such a threat without putting the responding help in jeopardy as well. It should be understood that these examples are illustrative, and therefore should not be construed as being limiting in any way. Regardless of how the distance is determined, the server computer 114 can be configured to identify one or more other devices 124 in proximity to the user device 102 based on the distances and/or location determined. It should be understood that this example is illustrative, and therefore should not be construed as being limiting in any way.

From operation 404, the method 400 can proceed to operation 406. At operation 406, the server computer 114 can deliver one or more alerts 130 to one or more of the other devices 124 identified in operation 404. According to various embodiments of the concepts and technologies disclosed herein, the delivery of the alerts 130 can be effected by the server computer 114, the edge device 116, and/or other devices (e.g., via text message, control channel messages, email, etc.). Additionally, it should be understood that the server computer 114 or edge device 116 may deliver the alerts 130 in some embodiments and/or that these or other devices may trigger delivery of the alerts 130. As such, operation 406 can correspond to one or more devices triggering delivery of one or more alerts. It should be understood that this example is illustrative, and therefore should not be construed as being limiting in any way.

In some embodiments of the concepts and technologies disclosed herein, the server computer 114 may determine, for example based on the type of security and/or safety threat determined, that any help (e.g., an entity summoned by way of the alerts illustrated and described herein) may be put at risk if they respond to the alerts 130. For example, if a safety threat such as a fire or criminal act is detected as the trigger for the monitoring, it may be inadvisable to alert some devices or not to alert some devices in the area as attempts to help may put entities associated with those devices at risk of personal injury. As such, the server computer 114 can be configured not to deliver any alerts 130 in some embodiments, or to deliver alerts 130 only to first responders or other specific entities in some embodiments of the concepts and technologies disclosed herein. It should be understood that this example is illustrative, and therefore should not be construed as being limiting in any way.

From operation 406, the method 400 can proceed to operation 408. At operation 408, the server computer 114 can determine if the alert 130 should be cancelled. In some embodiments, the server computer 114 may determine that the alert 130 should be cancelled if the server computer 114 determines, e.g., during continuing monitoring, that it would be unsafe for certain entities (e.g., entities alerted in operation 406) to continue or begin responding to the identified threat (e.g., the threat that has been previously identified and resulting in monitoring and alerting as illustrated and described herein). In some other embodiments, the server computer 114 may determine that the alert 130 should be cancelled by determining that the threat (e.g., the threat that has been previously identified and resulting in monitoring and alerting as illustrated and described herein) is over or has ended, or that a user of the user device 102 has indicated that help is not needed. It can be appreciated that in some embodiments of the concepts and technologies disclosed herein, the method 400 can end before operation 408, and that this is one example embodiment of the method 400.

At any rate, in some embodiments of the method 400 the server computer 114 can continue monitoring if an alert 130 is generated (as explained above with reference to operation 216) and operation 408 can correspond to the server computer 114 determining, while this monitoring continues, if the threat is over and/or that help is no longer needed or has been cancelled by the user device 102 or other entity. In some other embodiments, the server computer 114 may determine that one of the other devices 124 and/or the user device 102 has moved (making one or more of the other devices 124 that were alerted outside of the determined proximity distance of the user device 102 and/or no longer located in proximity to the user device 102). In yet other embodiments, the server computer 114 may determine that one or more of the other devices 124 that were alerted was alerted by mistake. In these and/or other cases, the server computer 114 may determine that the alert 130 should be cancelled.

If the server computer 114 determines, in operation 408, that the alert 130 should not be cancelled, flow of the method 400 can return to operation 408 (or execution of the method 400 can pause at operation 408). The pause at or iteration of operation 408 can continue until the server computer 114 determines that the alert 130 should be cancelled (e.g., that the threat is over or has ended; that movements render the devices out of proximity to one another; that a new threat exists; that help has arrived; etc.). If the server computer 114 determines that the alert 130 should be cancelled, the method 400 can proceed to operation 410.

At operation 410, the server computer 114 can cancel one or more of the alerts 130. Thus, the server computer 114 (or other entity) can generate a command 126 to cancel the alert 130 or otherwise trigger delivery of a command or request to cancel the alert 130. It should be understood that the server computer 114 or edge device 116 may deliver the command 126 or other request to cancel the alert 130 in some embodiments and/or that these or other devices may trigger delivery of the command 126 or other request to cancel the alert 130. As such, operation 410 can correspond to one or more devices triggering delivery of one or more commands 126, requests, or the like to cancel one or more alert 130. It should be understood that this example is illustrative, and therefore should not be construed as being limiting in any way.

From operation 410, the method 400 can proceed to operation 412. The method 400 can end at operation 412.

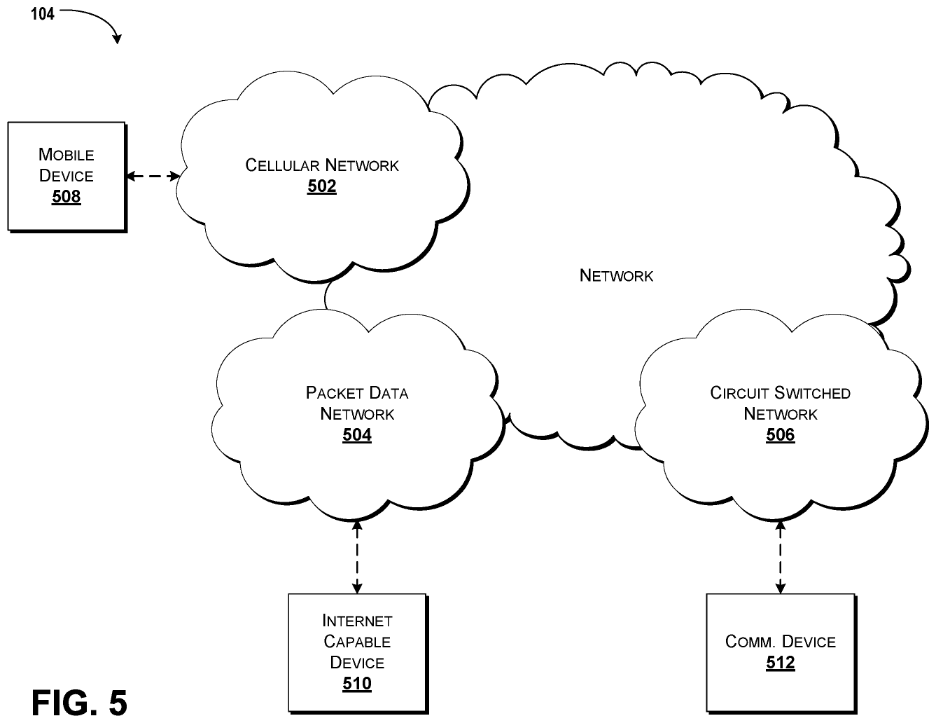

Turning now to FIG. 5, additional details of the network 104 are illustrated, according to an illustrative embodiment. The network 104 includes a cellular network 502, a packet data network 504, for example, the Internet, and a circuit switched network 506, for example, a publicly switched telephone network (“PSTN”). The cellular network 502 includes various components such as, but not limited to, base transceiver stations (“BTSs”), Node-B's or e-Node-B's, base station controllers (“BSCs”), radio network controllers (“RNCs”), mobile switching centers (“MSCs”), mobile management entities (“MMEs”), short message service centers (“SMSCs”), multimedia messaging service centers (“MMSCs”), home location registers (“HLRs”), home subscriber servers (“HSSs”), visitor location registers (“VLRs”), charging platforms, billing platforms, voicemail platforms, GPRS core network components, location service nodes, an IP Multimedia Subsystem (“IMS”), and the like. The cellular network 502 also includes radios and nodes for receiving and transmitting voice, data, and combinations thereof to and from radio transceivers, networks, the packet data network 504, and the circuit switched network 506.

A mobile communications device 508, such as, for example, a cellular telephone, a user equipment, a mobile terminal, a PDA, a laptop computer, a handheld computer, and combinations thereof, can be operatively connected to the cellular network 502. The cellular network 502 can be configured as a 2G GSM network and can provide data communications via GPRS and/or EDGE. Additionally, or alternatively, the cellular network 502 can be configured as a 3G UMTS network and can provide data communications via the HSPA protocol family, for example, HSDPA, EUL (also referred to as HSUPA), and HSPA+. The cellular network 502 also is compatible with 4G mobile communications standards, 5G mobile communications standards, other mobile communications standards, and evolved and future mobile communications standards.

The packet data network 504 includes various devices, for example, servers, computers, databases, and other devices in communication with one another, as is generally known. The packet data network 504 devices are accessible via one or more network links. The servers often store various files that are provided to a requesting device such as, for example, a computer, a terminal, a smartphone, or the like. Typically, the requesting device includes software (a “browser”) for executing a web page in a format readable by the browser or other software. Other files and/or data may be accessible via “links” in the retrieved files, as is generally known. In some embodiments, the packet data network 504 includes or is in communication with the Internet. The circuit switched network 506 includes various hardware and software for providing circuit switched communications. The circuit switched network 506 may include, or may be, what is often referred to as a plain old telephone system (POTS). The functionality of a circuit switched network 506 or other circuit-switched network are generally known and will not be described herein in detail.

The illustrated cellular network 502 is shown in communication with the packet data network 504 and a circuit switched network 506, though it should be appreciated that this is not necessarily the case. One or more Internet-capable devices 510, for example, a PC, a laptop, a portable device, or another suitable device, can communicate with one or more cellular networks 502, and devices connected thereto, through the packet data network 504. It also should be appreciated that the Internet-capable device 510 can communicate with the packet data network 504 through the circuit switched network 506, the cellular network 502, and/or via other networks (not illustrated).

As illustrated, a communications device 512, for example, a telephone, facsimile machine, modem, computer, or the like, can be in communication with the circuit switched network 506, and therethrough to the packet data network 504 and/or the cellular network 502. It should be appreciated that the communications device 512 can be an Internet-capable device, and can be substantially similar to the Internet-capable device 510. In the specification, the network 104 is used to refer broadly to any combination of the networks 502, 504, 506. It should be appreciated that substantially all of the functionality described with reference to the network 104 can be performed by the cellular network 502, the packet data network 504, and/or the circuit switched network 506, alone or in combination with other networks, network elements, and the like.

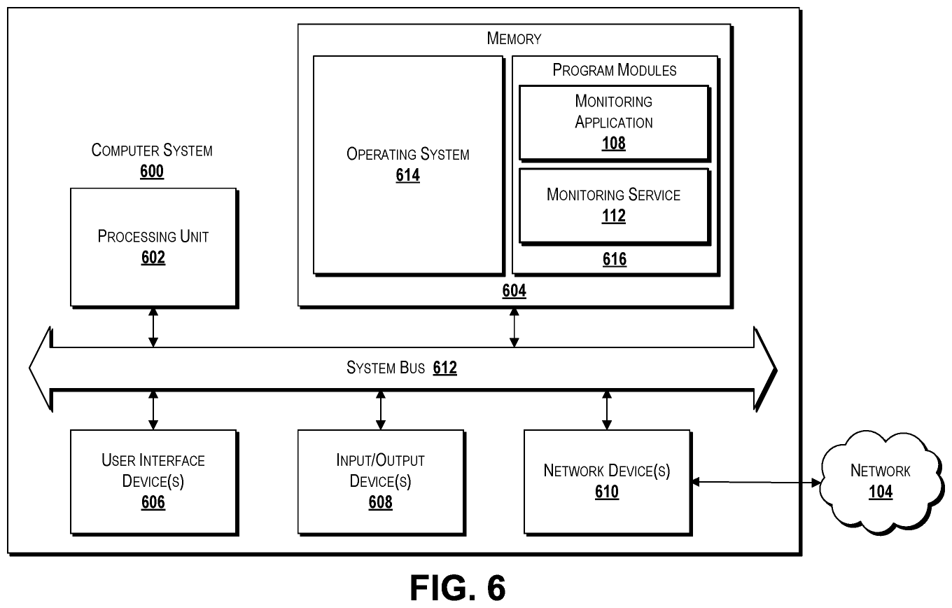

FIG. 6 is a block diagram illustrating a computer system 600 configured to provide the functionality described herein for providing and using a monitoring service, in accordance with various embodiments of the concepts and technologies disclosed herein. The computer system 600 includes a processing unit 602, a memory 604, one or more user interface devices 606, one or more input/output (“I/O”) devices 608, and one or more network devices 610, each of which is operatively connected to a system bus 612. The bus 612 enables bi-directional communication between the processing unit 602, the memory 604, the user interface devices 606, the I/O devices 608, and the network devices 610.

The processing unit 602 may be a standard central processor that performs arithmetic and logical operations, a more specific purpose programmable logic controller (“PLC”), a programmable gate array, or other type of processor known to those skilled in the art and suitable for controlling the operation of the server computer. As used herein, the word “processor” and/or the phrase “processing unit” when used with regard to any architecture or system can include multiple processors or processing units distributed across and/or operating in parallel in a single machine or in multiple machines. Furthermore, processors and/or processing units can be used to support virtual processing environments. Processors and processing units also can include state machines, application-specific integrated circuits (“ASICs”), combinations thereof, or the like. Because processors and/or processing units are generally known, the processors and processing units disclosed herein will not be described in further detail herein.

The memory 604 communicates with the processing unit 602 via the system bus 612. In some embodiments, the memory 604 is operatively connected to a memory controller (not shown) that enables communication with the processing unit 602 via the system bus 612. The memory 604 includes an operating system 614 and one or more program modules 616. The operating system 614 can include, but is not limited to, members of the WINDOWS, WINDOWS CE, and/or WINDOWS MOBILE families of operating systems from MICROSOFT CORPORATION, the LINUX family of operating systems, the SYMBIAN family of operating systems from SYMBIAN LIMITED, the BREW family of operating systems from QUALCOMM CORPORATION, the MAC OS, iOS, and/or LEOPARD families of operating systems from APPLE CORPORATION, the FREEBSD family of operating systems, the SOLARIS family of operating systems from ORACLE CORPORATION, other operating systems, and the like.

The program modules 616 may include various software and/or program modules described herein. In some embodiments, for example, the program modules 616 can include the monitoring application 108, the monitoring service 112, or other applications or services. These and/or other programs can be embodied in computer-readable media containing instructions that, when executed by the processing unit 602, perform one or more of the methods 200, 300, and 400 described in detail above with respect to FIGS. 2-4 and/or other functionality as illustrated and described herein. It can be appreciated that, at least by virtue of the instructions embodying the methods 200, 300, 400, and/or other functionality illustrated and described herein being stored in the memory 604 and/or accessed and/or executed by the processing unit 602, the computer system 600 is a special-purpose computing system that can facilitate providing the functionality illustrated and described herein. According to embodiments, the program modules 616 may be embodied in hardware, software, firmware, or any combination thereof. Although not shown in FIG. 6, it should be understood that the memory 604 also can be configured to store the captured data 110, the user models 118, the other information 120, the commands 126, the stream file 128, the alerts 130, and/or other data, if desired.

By way of example, and not limitation, computer-readable media may include any available computer storage media or communication media that can be accessed by the computer system 600. Communication media includes computer-readable instructions, data structures, program modules, or other data in a modulated data signal such as a carrier wave or other transport mechanism and includes any delivery media. The term “modulated data signal” means a signal that has one or more of its characteristics changed or set in a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

Computer storage media includes only non-transitory embodiments of computer readable media as illustrated and described herein. Thus, computer storage media can include volatile and non-volatile, removable and non-removable media implemented in any method or technology for storage of information such as computer-readable instructions, data structures, program modules, or other data. Computer storage media includes, but is not limited to, RAM, ROM, Erasable Programmable ROM (“EPROM”), Electrically Erasable Programmable ROM (“EEPROM”), flash memory or other solid state memory technology, CD-ROM, digital versatile disks (“DVD”), or other optical storage, magnetic cassettes, magnetic tape, magnetic disk storage or other magnetic storage devices, or any other medium which can be used to store the desired information and which can be accessed by the computer system 600. In the claims, the phrase “computer storage medium” and variations thereof does not include waves or signals per se and/or communication media.

The user interface devices 606 may include one or more devices with which a user accesses the computer system 600. The user interface devices 606 may include, but are not limited to, computers, servers, personal digital assistants, cellular phones, or any suitable computing devices. The I/O devices 608 enable a user to interface with the program modules 616. In one embodiment, the I/O devices 608 are operatively connected to an I/O controller (not shown) that enables communication with the processing unit 602 via the system bus 612. The I/O devices 608 may include one or more input devices, such as, but not limited to, a keyboard, a mouse, or an electronic stylus. Further, the I/O devices 608 may include one or more output devices, such as, but not limited to, a display screen or a printer.

The network devices 610 enable the computer system 600 to communicate with other networks or remote systems via a network, such as the network 104. Examples of the network devices 610 include, but are not limited to, a modem, a radio frequency (“RF”) or infrared (“IR”) transceiver, a telephonic interface, a bridge, a router, or a network card. The network 104 may include a wireless network such as, but not limited to, a Wireless Local Area Network (“WLAN”) such as a WI-FI network, a Wireless Wide Area Network (“WWAN”), a Wireless Personal Area Network (“WPAN”) such as BLUETOOTH, a Wireless Metropolitan Area Network (“WMAN”) such a WiMAX network, or a cellular network. Alternatively, the network 104 may be a wired network such as, but not limited to, a Wide Area Network (“WAN”) such as the Internet, a Local Area Network (“LAN”) such as the Ethernet, a wired Personal Area Network (“PAN”), or a wired Metropolitan Area Network (“MAN”).

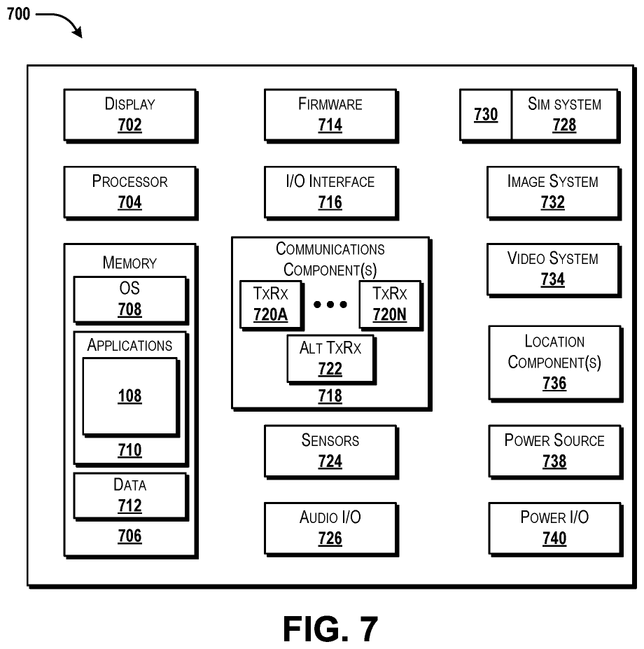

Turning now to FIG. 7, an illustrative mobile device 700 and components thereof will be described. In some embodiments, the user device 102, one or more of the data sources 122, and/or one or more of the other devices 124 described above with reference to FIGS. 1-4 can be configured as and/or can have an architecture similar or identical to the mobile device 700 described herein in FIG. 7. It should be understood, however, that the user device 102, the data sources 122, and/or the other devices 124 do not necessarily include the functionality described herein with reference to FIG. 7 in all embodiments. While connections are not shown between the various components illustrated in FIG. 7, it should be understood that some, none, or all of the components illustrated in FIG. 7 can be configured to interact with one another to carry out various device functions. In some embodiments, the components are arranged so as to communicate via one or more busses (not shown). Thus, it should be understood that FIG. 7 and the following description are intended to provide a general understanding of a suitable environment in which various aspects of embodiments can be implemented, and should not be construed as being limiting in any way.

As illustrated in FIG. 7, the mobile device 700 can include a display 702 for displaying data. According to various embodiments, the display 702 can be configured to display various graphical user interface (“GUI”) elements such as, for example, options for activating monitoring, options for deactivating monitoring, options for setting the duration of monitoring, options for streaming certain types of data, text, images, video, virtual keypads and/or keyboards, messaging data, notification messages, metadata, internet content, device status, time, date, calendar data, device preferences, map and location data, combinations thereof, and/or the like. The mobile device 700 also can include a processor 704 and a memory or other data storage device (“memory”) 706. The processor 704 can be configured to process data and/or can execute computer-executable instructions stored in the memory 706. The computer-executable instructions executed by the processor 704 can include, for example, an operating system 708, one or more applications 710 such as the monitoring application 108, the monitoring service 112, other computer-executable instructions stored in a memory 706, or the like. In some embodiments, the applications 710 also can include a UI application (not illustrated in FIG. 7).

The UI application can interface with the operating system 708, such as the operating system 106 shown in FIG. 1, to facilitate user interaction with functionality and/or data stored at the mobile device 700 and/or stored elsewhere. In some embodiments, the operating system 708 can include a member of the SYMBIAN OS family of operating systems from SYMBIAN LIMITED, a member of the WINDOWS MOBILE OS and/or WINDOWS PHONE OS families of operating systems from MICROSOFT CORPORATION, a member of the PALM WEBOS family of operating systems from HEWLETT PACKARD CORPORATION, a member of the BLACKBERRY OS family of operating systems from RESEARCH IN MOTION LIMITED, a member of the IOS family of operating systems from APPLE INC., a member of the ANDROID OS family of operating systems from GOOGLE INC., and/or other operating systems. These operating systems are merely illustrative of some contemplated operating systems that may be used in accordance with various embodiments of the concepts and technologies described herein and therefore should not be construed as being limiting in any way.

The UI application can be executed by the processor 704 to aid a user in entering content, activating monitoring, deactivating monitoring, setting durations of monitoring, sending the alerts 130, configuring settings, manipulating address book content and/or settings, multimode interaction, interacting with other applications 710, and otherwise facilitating user interaction with the operating system 708, the applications 710, and/or other types or instances of data 712 that can be stored at the mobile device 700. The data 712 can include, for example, the monitoring application 108, the captured data 110, the monitoring service 112, the user models 118, the other information 120, the commands 126, the stream file 128, the alerts 130, and/or other data, applications, services, and/or program modules. According to various embodiments, the data 712 can include, for example, presence applications, visual voice mail applications, messaging applications, text-to-speech and speech-to-text applications, add-ons, plug-ins, email applications, music applications, video applications, camera applications, location-based service applications, power conservation applications, game applications, productivity applications, entertainment applications, enterprise applications, combinations thereof, and the like. The applications 710, the data 712, and/or portions thereof can be stored in the memory 706 and/or in a firmware 714, and can be executed by the processor 704.

It can be appreciated that, at least by virtue of storage of the instructions corresponding to the applications 710 and/or other instructions embodying other functionality illustrated and described herein in the memory 706, and/or by virtue of the instructions corresponding to the applications 710 and/or other instructions embodying other functionality illustrated and described herein being accessed and/or executed by the processor 704, the mobile device 700 is a special-purpose mobile device that can facilitate providing the functionality illustrated and described herein. The firmware 714 also can store code for execution during device power up and power down operations. It can be appreciated that the firmware 714 can be stored in a volatile or non-volatile data storage device including, but not limited to, the memory 706 and/or a portion thereof.

The mobile device 700 also can include an input/output (“I/O”) interface 716. The I/O interface 716 can be configured to support the input/output of data such as location information, the captured data 110, the user models 118, the other information 120, the commands 126, the stream file 128, the alerts 130, user information, organization information, presence status information, user IDs, passwords, and application initiation (start-up) requests. In some embodiments, the I/O interface 716 can include a hardwire connection such as a universal serial bus (“USB”) port, a mini-USB port, a micro-USB port, an audio jack, a PS2 port, an IEEE 1394 (“FIREWIRE”) port, a serial port, a parallel port, an Ethernet (RJ45 or RJ48) port, a telephone (RJ11 or the like) port, a proprietary port, combinations thereof, or the like. In some embodiments, the mobile device 700 can be configured to synchronize with another device to transfer content to and/or from the mobile device 700. In some embodiments, the mobile device 700 can be configured to receive updates to one or more of the applications 710 via the I/O interface 716, though this is not necessarily the case. In some embodiments, the I/O interface 716 accepts I/O devices such as keyboards, keypads, mice, interface tethers, printers, plotters, external storage, touch/multi-touch screens, touch pads, trackballs, joysticks, microphones, remote control devices, displays, projectors, medical equipment (e.g., stethoscopes, heart monitors, and other health metric monitors), modems, routers, external power sources, docking stations, combinations thereof, and the like. It should be appreciated that the I/O interface 716 may be used for communications between the mobile device 700 and a network device or local device.

The mobile device 700 also can include a communications component 718. The communications component 718 can be configured to interface with the processor 704 to facilitate wired and/or wireless communications with one or more networks such as the network 104 described herein. In some embodiments, other networks include networks that utilize non-cellular wireless technologies such as WI-FI or WIMAX. In some embodiments, the communications component 718 includes a multimode communications subsystem for facilitating communications via the cellular network and one or more other networks.

The communications component 718, in some embodiments, includes one or more transceivers. The one or more transceivers, if included, can be configured to communicate over the same and/or different wireless technology standards with respect to one another. For example, in some embodiments one or more of the transceivers of the communications component 718 may be configured to communicate using GSM, CDMAONE, CDMA2000, LTE, and various other 2G, 2.5G, 3G, 4G, 5G, and greater generation technology standards. Moreover, the communications component 718 may facilitate communications over various channel access methods (which may or may not be used by the aforementioned standards) including, but not limited to, TDMA, FDMA, W-CDMA, OFDM, SDMA, and the like.

In addition, the communications component 718 may facilitate data communications using GPRS, EDGE, the HSPA protocol family including HSDPA, EUL or otherwise termed HSDPA, HSPA+, and various other current and future wireless data access standards. In the illustrated embodiment, the communications component 718 can include a first transceiver (“TxRx”) 720A that can operate in a first communications mode (e.g., GSM). The communications component 718 also can include an N^{th} transceiver (“TxRx”) 720N that can operate in a second communications mode relative to the first transceiver 720A (e.g., UMTS). While two transceivers 720A-N (hereinafter collectively and/or generically referred to as “transceivers 720”) are shown in FIG. 7, it should be appreciated that less than two, two, and/or more than two transceivers 720 can be included in the communications component 718.

The communications component 718 also can include an alternative transceiver (“Alt TxRx”) 722 for supporting other types and/or standards of communications. According to various contemplated embodiments, the alternative transceiver 722 can communicate using various communications technologies such as, for example, WI-FI, WIMAX, BLUETOOTH, infrared, infrared data association (“IRDA”), near field communications (“NFC”), other RF technologies, combinations thereof, and the like. In some embodiments, the communications component 718 also can facilitate reception from terrestrial radio networks, digital satellite radio networks, internet-based radio service networks, combinations thereof, and the like. The communications component 718 can process data from a network such as the Internet, an intranet, a broadband network, a WI-FI hotspot, an Internet service provider (“ISP”), a digital subscriber line (“DSL”) provider, a broadband provider, combinations thereof, or the like.

The mobile device 700 also can include one or more sensors 724. The sensors 724 can include temperature sensors, light sensors, air quality sensors, movement sensors, orientation sensors, noise sensors, proximity sensors, or the like. As such, it should be understood that the sensors 724 can include, but are not limited to, accelerometers, magnetometers, gyroscopes, infrared sensors, noise sensors, microphones, combinations thereof, or the like. Additionally, audio capabilities for the mobile device 700 may be provided by an audio I/O component 726. The audio I/O component 726 of the mobile device 700 can include one or more speakers for the output of audio signals, one or more microphones for the collection and/or input of audio signals, and/or other audio input and/or output devices.

The illustrated mobile device 700 also can include a subscriber identity module (“SIM”) system 728. The SIM system 728 can include a universal SIM (“USIM”), a universal integrated circuit card (“UICC”) and/or other identity devices. The SIM system 728 can include and/or can be connected to or inserted into an interface such as a slot interface 730. In some embodiments, the slot interface 730 can be configured to accept insertion of other identity cards or modules for accessing various types of networks. Additionally, or alternatively, the slot interface 730 can be configured to accept multiple subscriber identity cards. Because other devices and/or modules for identifying users and/or the mobile device 700 are contemplated, it should be understood that these embodiments are illustrative, and should not be construed as being limiting in any way.

The mobile device 700 also can include an image capture and processing system 732 (“image system”). The image system 732 can be configured to capture or otherwise obtain photos, videos, and/or other visual information. As such, the image system 732 can include cameras, lenses, charge-coupled devices (“CCDs”), combinations thereof, or the like. The mobile device 700 may also include a video system 734. The video system 734 can be configured to capture, process, record, modify, and/or store video content. Photos and videos obtained using the image system 732 and the video system 734, respectively, may be added as message content to an MMS message, email message, and sent to another mobile device. The video and/or photo content also can be shared with other devices via various types of data transfers via wired and/or wireless communication devices as described herein.

The mobile device 700 also can include one or more location components 736. The location components 736 can be configured to send and/or receive signals to determine a geographic location of the mobile device 700. According to various embodiments, the location components 736 can send and/or receive signals from global positioning system (“GPS”) devices, assisted-GPS (“A-GPS”) devices, WI-FI/WIMAX and/or cellular network triangulation data, combinations thereof, and the like. The location component 736 also can be configured to communicate with the communications component 718 to retrieve triangulation data for determining a location of the mobile device 700. In some embodiments, the location component 736 can interface with cellular network nodes, telephone lines, satellites, location transmitters and/or beacons, wireless network transmitters and receivers, combinations thereof, and the like. In some embodiments, the location component 736 can include and/or can communicate with one or more of the sensors 724 such as a compass, an accelerometer, and/or a gyroscope to determine the orientation of the mobile device 700. Using the location component 736, the mobile device 700 can generate and/or receive data to identify its geographic location, or to transmit data used by other devices to determine the location of the mobile device 700. The location component 736 may include multiple components for determining the location and/or orientation of the mobile device 700.

The illustrated mobile device 700 also can include a power source 738. The power source 738 can include one or more batteries, power supplies, power cells, and/or other power subsystems including alternating current (“AC”) and/or direct current (“DC”) power devices. The power source 738 also can interface with an external power system or charging equipment via a power I/O component 740. Because the mobile device 700 can include additional and/or alternative components, the above embodiment should be understood as being illustrative of one possible operating environment for various embodiments of the concepts and technologies described herein. The described embodiment of the mobile device 700 is illustrative, and should not be construed as being limiting in any way.

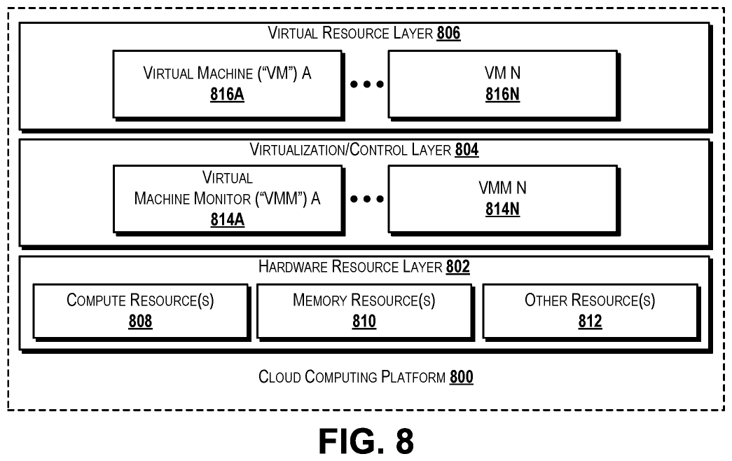

FIG. 8 illustrates an illustrative architecture for a cloud computing platform 800 that can be capable of executing the software components described herein for providing and using a monitoring service and/or for interacting with the monitoring application 108 and/or the monitoring service 112. Thus, it can be appreciated that in some embodiments of the concepts and technologies disclosed herein, the cloud computing platform 800 illustrated in FIG. 8 can be used to provide the functionality described herein with respect to the user device 102, the server computer 114, the edge device 116, the data sources 122, and/or the other devices 124.

The cloud computing platform 800 thus may be utilized to execute any aspects of the software components presented herein. Thus, according to various embodiments of the concepts and technologies disclosed herein, the monitoring application 108 and/or the monitoring service 112 can be implemented, at least in part, on or by elements included in the cloud computing platform 800 illustrated and described herein. Those skilled in the art will appreciate that the cloud computing platform 800 illustrated in FIG. 8 is a simplification of but only one possible implementation of an illustrative cloud computing platform, and as such, the cloud computing platform 800 illustrated in FIG. 8 should not be construed as being limiting in any way.

In the illustrated embodiment, the cloud computing platform 800 can include a hardware resource layer 802, a virtualization/control layer 804, and a virtual resource layer 806. These layers and/or other layers can be configured to cooperate with each other and/or other elements of a cloud computing platform 800 to perform operations as will be described in detail herein. While connections are shown between some of the components illustrated in FIG. 8, it should be understood that some, none, or all of the components illustrated in FIG. 8 can be configured to interact with one another to carry out various functions described herein. In some embodiments, the components are arranged so as to communicate via one or more networks such as, for example, the network 104 illustrated and described hereinabove (not shown in FIG. 8). Thus, it should be understood that FIG. 8 and the following description are intended to provide a general understanding of a suitable environment in which various aspects of embodiments can be implemented, and should not be construed as being limiting in any way.

The hardware resource layer 802 can provide hardware resources. In the illustrated embodiment, the hardware resources can include one or more compute resources 808, one or more memory resources 810, and one or more other resources 812. The compute resource(s) 808 can include one or more hardware components that can perform computations to process data, and/or to execute computer-executable instructions of one or more application programs, operating systems, services, and/or other software including, but not limited to, the monitoring application 108 and/or the monitoring service 112 illustrated and described herein.

According to various embodiments, the compute resources 808 can include one or more central processing units (“CPUs”). The CPUs can be configured with one or more processing cores. In some embodiments, the compute resources 808 can include one or more graphics processing units (“GPUs”). The GPUs can be configured to accelerate operations performed by one or more CPUs, and/or to perform computations to process data, and/or to execute computer-executable instructions of one or more application programs, operating systems, and/or other software that may or may not include instructions that are specifically graphics computations and/or related to graphics computations. In some embodiments, the compute resources 808 can include one or more discrete GPUs. In some other embodiments, the compute resources 808 can include one or more CPU and/or GPU components that can be configured in accordance with a co-processing CPU/GPU computing model. Thus, it can be appreciated that in some embodiments of the compute resources 808, a sequential part of an application can execute on a CPU and a computationally-intensive part of the application can be accelerated by the GPU. It should be understood that this example is illustrative, and therefore should not be construed as being limiting in any way.

In some embodiments, the compute resources 808 also can include one or more system on a chip (“SoC”) components. It should be understood that an SoC component can operate in association with one or more other components as illustrated and described herein, for example, one or more of the memory resources 810 and/or one or more of the other resources 812. In some embodiments in which an SoC component is included, the compute resources 808 can be or can include one or more embodiments of the SNAPDRAGON brand family of SoCs, available from QUALCOMM of San Diego, California; one or more embodiment of the TEGRA brand family of SoCs, available from NVIDIA of Santa Clara, California; one or more embodiment of the HUMMINGBIRD brand family of SoCs, available from SAMSUNG of Seoul, South Korea; one or more embodiment of the Open Multimedia Application Platform (“OMAP”) family of SoCs, available from TEXAS INSTRUMENTS of Dallas, Texas; one or more customized versions of any of the above SoCs; and/or one or more other brand and/or one or more proprietary SoCs.

The compute resources 808 can be or can include one or more hardware components arranged in accordance with an ARM architecture, available for license from ARM HOLDINGS of Cambridge, United Kingdom. Alternatively, the compute resources 808 can be or can include one or more hardware components arranged in accordance with an x86 architecture, such as an architecture available from INTEL CORPORATION of Mountain View, California, and others. Those skilled in the art will appreciate the implementation of the compute resources 808 can utilize various computation architectures and/or processing architectures. As such, the various example embodiments of the compute resources 808 as mentioned hereinabove should not be construed as being limiting in any way. Rather, implementations of embodiments of the concepts and technologies disclosed herein can be implemented using compute resources 808 having any of the particular computation architecture and/or combination of computation architectures mentioned herein as well as other architectures.

Although not separately illustrated in FIG. 8, it should be understood that the compute resources 808 illustrated and described herein can host and/or execute various services, applications, portals, and/or other functionality illustrated and described herein. Thus, the compute resources 808 can host and/or can execute the monitoring application 108, the monitoring service 112, and/or other applications or services illustrated and described herein.

The memory resource(s) 810 can include one or more hardware components that can perform or provide storage operations, including temporary and/or permanent storage operations. In some embodiments, the memory resource(s) 810 can include volatile and/or non-volatile memory implemented in any method or technology for storage of information such as computer-readable instructions, data structures, program modules, or other data disclosed herein. Computer storage media is defined hereinabove and therefore should be understood as including, in various embodiments, random access memory (“RAM”), read-only memory (“ROM”), Erasable Programmable ROM (“EPROM”), Electrically Erasable Programmable ROM (“EEPROM”), flash memory or other solid state memory technology, CD-ROM, digital versatile disks (“DVD”), or other optical storage, magnetic cassettes, magnetic tape, magnetic disk storage or other magnetic storage devices, or any other medium that can be used to store data and that can be accessed by the compute resources 808, subject to the definition of “computer storage media” provided above (e.g., as excluding waves and signals per se and/or communication media as defined in this application).

Although not illustrated in FIG. 8, it should be understood that the memory resources 810 can host or store the various data illustrated and described herein including, but not limited to, the captured data 110, the user models 118, the other information 120, the commands 126, the stream file 128, the alerts 130, and/or other data, if desired. It should be understood that this example is illustrative, and therefore should not be construed as being limiting in any way.

The other resource(s) 812 can include any other hardware resources that can be utilized by the compute resources(s) 808 and/or the memory resource(s) 810 to perform operations. The other resource(s) 812 can include one or more input and/or output processors (e.g., a network interface controller and/or a wireless radio), one or more modems, one or more codec chipsets, one or more pipeline processors, one or more fast Fourier transform (“FFT”) processors, one or more digital signal processors (“DSPs”), one or more speech synthesizers, combinations thereof, or the like.

The hardware resources operating within the hardware resource layer 802 can be virtualized by one or more virtual machine monitors (“VMMs”) 814A-814N (also known as “hypervisors;” hereinafter “VMMs 814”). The VMMs 814 can operate within the virtualization/control layer 804 to manage one or more virtual resources that can reside in the virtual resource layer 806. The VMMs 814 can be or can include software, firmware, and/or hardware that alone or in combination with other software, firmware, and/or hardware, can manage one or more virtual resources operating within the virtual resource layer 806.

The virtual resources operating within the virtual resource layer 806 can include abstractions of at least a portion of the compute resources 808, the memory resources 810, the other resources 812, or any combination thereof. These abstractions are referred to herein as virtual machines (“VMs”). In the illustrated embodiment, the virtual resource layer 806 includes VMs 816A-816N (hereinafter “VMs 816”).

Based on the foregoing, it should be appreciated that systems and methods for providing and using a monitoring service have been disclosed herein. Although the subject matter presented herein has been described in language specific to computer structural features, methodological and transformative acts, specific computing machinery, and computer-readable media, it is to be understood that the concepts and technologies disclosed herein are not necessarily limited to the specific features, acts, or media described herein. Rather, the specific features, acts and mediums are disclosed as example forms of implementing the concepts and technologies disclosed herein.

The subject matter described above is provided by way of illustration only and should not be construed as limiting. Various modifications and changes may be made to the subject matter described herein without following the example embodiments and applications illustrated and described, and without departing from the true spirit and scope of the embodiments of the concepts and technologies disclosed herein.

1. A system comprising:
a processor; and
a memory that stores computer-executable instructions that, when executed by the processor, cause the processor to perform operations comprising
detecting a monitoring trigger that indicates that monitoring of a user device is to be initiated,
identifying a time period associated with the monitoring,
triggering the monitoring of the user device, wherein the monitoring comprises obtaining video associated with the user device, wherein the video is streamed to an edge device,
analyzing the video to determine if a threat is detected,
if a determination is made that the threat is not detected, triggering termination of the monitoring and deletion of the video, and
if a determination is made that the threat is detected, triggering delivery of an alert to another device.

2. The system of claim 1, wherein the computer-executable instructions, when executed by the processor, cause the processor to perform operations further comprising:
determining, during the monitoring, that the monitoring has not been deactivated;
determining, during the monitoring, that the time period has lapsed; and
analyzing the video in response to determining that the time period has lapsed without the monitoring being deactivated.

3. The system of claim 1, wherein the time period comprises an amount of time for which the monitoring is to be performed.

4. The system of claim 1, wherein detecting the monitoring trigger comprises detecting selection, at the user device, of a control to begin monitoring of the user device.

5. The system of claim 1, wherein detecting the monitoring trigger comprises:
detecting selection, at the user device, of a control to begin monitoring of the user device after the time period if the monitoring is not deactivated before the time period lapses;
determining that the time period lapsed; and
determining that the monitoring was not deactivated before the time period lapsed.

6. The system of claim 5, wherein determining that the monitoring has been deactivated comprises determining that an explicit request to deactivate the monitoring has been received from the user device.

7. The system of claim 5, wherein determining that the monitoring has been deactivated comprises detecting initiation of a network connection between the user device and another device.

8. A method comprising:
detecting, at a computer comprising a processor, a monitoring trigger that indicates that monitoring of a user device is to be initiated;
identifying, by the processor, a time period associated with the monitoring;
triggering, by the processor, the monitoring of the user device, wherein the monitoring comprises obtaining video associated with the user device, wherein the video is streamed to an edge device;
analyzing, by the processor, the video to determine if a threat is detected;
if a determination is made that the threat is not detected, triggering, by the processor, termination of the monitoring and deletion of the video; and
if a determination is made that the threat is detected, triggering, by the processor, delivery of an alert to another device.

9. The method of claim 8, further comprising:
determining, during the monitoring, that the monitoring has not been deactivated;
determining, during the monitoring, that the time period has lapsed; and
analyzing the video in response to determining that the time period has lapsed without the monitoring being deactivated.

10. The method of claim 8, wherein detecting the monitoring trigger comprises:
detecting selection, at the user device, of a control to begin monitoring of the user device after the time period if the monitoring is not deactivated before the time period lapses;
determining that the time period lapsed; and
determining that the monitoring was not deactivated before the time period lapsed.

11. The method of claim 8, wherein triggering delivery of the alert comprises:
identifying a geographic location of the user device;
identifying, based on the geographic location, a plurality of devices that are located in proximity to the user device, the plurality of devices comprising the other device; and
triggering the delivery of the alert to the other device.

12. The method of claim 11, further comprising:
in response to determining that the alert should be cancelled, cancelling the alert, wherein determining that the alert should be cancelled comprises determining that the other device is no longer in proximity to the user device.

13. The method of claim 11, further comprising:
in response to determining that the alert should be cancelled, cancelling the alert, wherein determining that the alert should be cancelled comprises receiving a notification that help is no longer needed at the user device.

14. A computer storage medium having computer-executable instructions stored thereon that, when executed by a processor, cause the processor to perform operations comprising:
detecting a monitoring trigger that indicates that monitoring of a user device is to be initiated;
identifying a time period associated with the monitoring;
triggering the monitoring of the user device, wherein the monitoring includes capturing video and streaming the video to an edge device, and wherein the video is analyzed to determine if a threat is detected;
if a determination is made that the threat is not detected, triggering termination of the monitoring and deletion of the video; and
if a determination is made that the threat is detected, triggering delivery of an alert to another device.

15. The computer storage medium of claim 14, wherein the computer-executable instructions, when executed by the processor, cause the processor to perform operations further comprising:
determining, during the monitoring, that the monitoring has not been deactivated;
determining, during the monitoring, that the time period has lapsed; and
analyzing the video in response to determining that the time period has lapsed without the monitoring being deactivated.

16. The computer storage medium of claim 14, wherein the video is analyzed at the edge device by applying, to the video, machine learning and artificial intelligence to determine if the threat is detected.

17. The computer storage medium of claim 14, wherein detecting the monitoring trigger comprises detecting selection, at the user device, of a control to begin monitoring of the user device.

18. The computer storage medium of claim 14, wherein detecting the monitoring trigger comprises:
detecting selection, at the user device, of a control to begin monitoring of the user device after the time period if the monitoring is not deactivated before the time period lapses;
determining that the time period lapsed; and
determining that the monitoring was not deactivated before the time period lapsed.

19. The computer storage medium of claim 18, wherein determining that the monitoring has been deactivated comprises determining that an explicit request to deactivate the monitoring has been received from the user device.

20. The computer storage medium of claim 18, wherein determining that the monitoring has been deactivated comprises detecting initiation of a network connection between the user device and another device.
